(19) United States
(12) Patent Application Publication
(10) Pub. No.: US 2025/0328934 A1
(43) Pub. Date: Oct. 23, 2025

(54) System and Methods for Regenerating Content Based on User Reactions to the Content

(71) Applicant: Adeia Guides Inc., San Jose, CA (US)

(72) Inventors: Serhad DOKEN, Bryn Mawr, PA (US); Jean-Yves COULEAUD, Mission Viejo, CA (US); Ning XU, Irvine, CA (US)

(21) Appl. No.: 18/639,311

(22) Filed: Apr. 18, 2024

(51) Int. Cl. G06Q 30/0282; G06Q 50/00

(52) U.S. Cl. CPC G06Q 30/0282; G06Q 50/01

(57) ABSTRACT

Systems and methods are described for identifying content on a social media platform and reactions thereto. The system may input, to a first machine learning model, data indicating the reactions, and receive, as output, sentiment data for the reactions. The system may determine, based on the sentiment data, a reaction having a negative sentiment. The system may identify, as a portion of the content to be modified, a portion of the content corresponding to a portion of the reaction having the negative sentiment, and input, to a second machine learning model, data indicating at least a portion of the content and data indicating the identified portion of the content. The system may receive, as output, a regenerated version of the content, and cause the content on the social media platform to be modified based on, or supplemented with the regenerated version of the content.

### BACKGROUND

This disclosure is directed to systems and methods for regenerating content based on reactions of users to the content. In particular, techniques are disclosed for using one or more machine learning models to automatically regenerate content based on a sentiment and/or semantic analysis of the reactions of users to the content.

### SUMMARY

In recent years, the proliferation of social media has had a profound impact on society, changing the way users interact and communicate with each other. Various social media platforms (e.g., Instagram®, Facebook®, Snapchat®, LinkedIn®, etc.) allow users to interact over a computer network with users in all parts of the world. Social media platforms may permit a user to create a profile, and users often associate the profile with their given names so as to be easily identifiable to friends, family, colleagues, etc. As more and more people use social media platforms every day, many companies use their social media accounts, and/or social media accounts of celebrities and social influencers, to promote or advertise their products and/or brands. While social media overall might be seen as a positive development for companies by providing more opportunities to connect with consumers, there is also a risk of alienating users (or a particular portion of users) if a certain social media post associated with their company or product is controversial, false, negative, or objectionable to these users or the particular portion of the users. Moreover, once content is on a social media platform or other online platform, such content can quickly become “viral,” and it may exacerbate the problem for the company if such content is rapidly disseminated across the internet.

In one approach, to measure how a certain party or company's content is being received by online users, a large team of human reviewers monitors multiple social media platforms and/or other online platforms to determine how many users are interacting with certain content, and/or the types of comments or interactions that users are making or having with the content. This approach, however, relies on the subjective determinations of the human reviewers browsing through the websites as to whether the content is receiving positive feedback from users, and it is time-consuming and tedious (and potentially expensive) for the reviewers to examine all the interactions with a certain entity's or party's content. Further, such reviewers may have to spend time sifting through interactions with the content from “bots” or other unverified users, which may not be relevant to the content of interest and/or may not warrant consideration. Moreover, even if the employee identifies content that should be replaced, it may take a substantial amount of time for such content to be removed and replaced with adequate replacement content that might be more acceptable to users. At this point, the content may have been viewed by numerous users and shared across numerous websites, platforms, and users. Moreover, the platform's use of computing resources and/or networking resources to continue to render and transmit such content to client devices, despite the negative reception to such content (e.g., based on the content being inaccurate, offensive, and/or obsolete), is an inefficient use of resources.

In another approach, a company may run a focus group to understand what alienated their target audience by reaching out to individuals who have viewed or commented on the content to invite them to the focus group and ask for their opinions regarding the content. However, organizing such a focus group may be a time-consuming and expensive effort that leads to an unacceptable time delay for identifying and correcting undesirable content. What is needed is an efficient, reliable, and automated process for identifying that there is problematic content, determining what particular portion of the content is problematic, and regenerating the content to address such problems.

To help overcome these problems, system(s), method(s) and apparatus(es) (e.g., a computing device comprising control circuitry and a non-transitory computer-readable medium) are described herein for providing a regenerated version of content. The system(s) may identify content being displayed on a social media platform (and/or any other suitable platform), and identify a plurality of reactions to the content from a plurality of users of the social media platform. The system(s) may input, to a first machine learning model, data indicating the plurality of reactions, and receive, as output from the first machine learning model, sentiment data for the plurality of reactions. The system(s) may determine, based on the sentiment data for the plurality of reactions output from the first machine learning model, at least one reaction of the plurality of reactions having a negative sentiment, and identifying, as at least one portion of the content that is to be modified, a portion of the content corresponding to a portion of the at least one reaction having the negative sentiment. The system(s) may input, to a second machine learning model, data indicating at least a portion of the content and data indicating the identified portion of the content, and receive, as output from the second machine learning model, a regenerated version of the content. The system(s) may cause the content on the social media platform to be modified based on, or supplemented with, the regenerated version of the content. In some embodiments, the social media platform may additionally or alternatively correspond to or comprise an advertising platform, an e-commerce platform, a content management platform, a content sharing platform, a content editing platform, a video distribution platform, a restaurant review platform, a travel platform, or any other suitable content platform, or any combination thereof.

Such aspects may enable content providers to leverage various computer-implemented techniques (e.g., one or more machine learning models) to automatically and efficiently identify content that is a candidate to be regenerated (based on sentiment data of, and/or semantic analysis of, reactions to the content), and to automatically and efficiently identify a portion of the content, referenced in at least one of the reactions or comments having a negative sentiment, that is to be replaced in a regenerated version of the content or omitted from the regenerated version of the content, which may be posted to the platform instead of the original content. The system(s) provided herein may provide these advantageous aspects in a timely and efficient manner, without having to rely on subjective determinations of (and without having to compensate) a large group of people tasked with monitoring multiple websites and/or online platforms. In some embodiments, the system may strike a balance between conserving resources by, e.g., using resources to regenerate only content that has been viewed or interacted with by a threshold number of users, while at the same time performing such regenerating content in a timely and efficient manner to minimize the number of users exposed to the potentially offensive, incorrect or otherwise undesirable content.

In some embodiments, the sentiment data classifies each reaction of the plurality of reactions as having a positive sentiment, a neutral sentiment, or a negative sentiment. In some embodiments, the first machine learning model may receive an suitable number of reactions as input, and output a comprehensive output indicating whether and where is the negative sentiment (or whether and where is another type of sentiment), instead of doing so for each of the reactions. The system(s) may identify a replacement portion to be used in the regenerated version of the content instead of the identified portion of the content, the replacement portion having a positive or a neutral sentiment. The replacement portion may correspond to the data indicating the identified portion of the content that is input to the second machine learning model. For example, if such identified portion of the content is text having a negative sentiment, a counterpart word(s) (e.g., antonym(s)) may be identified for use in the regenerated version of the content instead of the identified portion of the content, and/or one or more computer-implemented techniques (e.g., a machine learning model) may be used to identify a suitable replacement word(s). As another example, a natural language description of a portion of an image having a negative sentiment may be obtained, and the system(s) may generate a related natural language description having a positive or neutral sentiment and a portion of an image based on such related natural description, for use in the regenerated version of the content instead of the portion of an image associated with the natural language description having the negative sentiment.

In some embodiments, the system(s) may determine that there is negative sentiment in one or more reactions in relation to audio of originally posted content, and the system may obtain a textual representation of such audio, and identify a positive or neutral counterpart for such audio, for use in obtaining a regenerated version of the originally posted content. In some embodiments, the system(s) may determine, based on one or more reactions to content, that text of the originally posted content is inappropriately capitalized, or has a sub-optimal size or font or other characteristics causing a negative sentiment, and the system(s) may perform correction of such characteristics of the text. In some embodiments, slang or jargon may be corrected or inserted in the corrected content, based on analysis of reactions to the original content.

In some embodiments, the plurality of reactions comprise a plurality of comments posted to the social media platform in association with the content.

In some embodiments, the system(s) may be configured to receive, as the output from the first machine learning model, the sentiment data for the plurality of reactions by receiving data indicating a number of the plurality of comments having a negative sentiment. The system(s) may identify the replacement portion to be used in the regenerated version of the content instead of the portion of the content in response to determining that a number of the first plurality of comments that reference the identified portion of the content exceeds a threshold.

In some embodiments, the system(s) may be configured to input, to the second machine learning model, the data indicating at least a portion of the content and the data indicating the identified portion of the content is in response to determining that the number of the plurality of comments having the negative sentiment exceeds a threshold.

In some embodiments, the data indicating the identified portion of the content that is input to the second machine learning model comprises an indication to omit the identified portion of the content from the regenerated version of the content.

In some embodiments, the system(s) may be configured to determine that a number of interactions with at least one comment of the plurality of comments exceeds a threshold, and to use the second machine learning model to regenerate the content as modified content based at least in part on determining that the number of interactions with the at least one comment exceeds the threshold.

In some embodiments, the system(s) may be configured to identify the plurality of reactions to the content from the plurality of users of the social media platform by for each respective user of the plurality of users, analyzing profile data of the user to determine whether a user profile of the user is a valid user profile, and for each respective comment of the plurality of comments, analyzing text of the comment to determine whether the comment is relevant to the content. The system(s) may identify the plurality of reactions to the content from the plurality of users of the social media platform based on determining that each of the plurality of users is associated with a valid user profile, and each of the plurality of comments is relevant to the content.

In some embodiments, the system(s) may be configured to identify a number of users (e.g., verified users of the social media platform) that have reacted to the content or viewed the content; determine that the number of users is above a threshold number; and in response to determining that the number of users is above the threshold number, input, to the first machine learning model, the data indicating the plurality of reactions.

In some embodiments, the system(s) may be configured to identify a first number of users that have viewed the content without commenting on, liking, disliking, or sharing the content, and identify a second number of users that have interacted with the content by commenting on, liking, disliking, or sharing (and/or reposting) the content. The system(s) may determine a ratio of the first number to the second number, and, in response to determining that the ratio exceeds a threshold, input, to the first machine learning model, the data indicating the plurality of reactions.

In some embodiments, the system(s) may be configured to transmit a recommendation, to a content provider associated with the content, to replace the content with the regenerated version of the content, wherein causing the content on the social media platform to be modified based on (e.g., replaced with), or supplemented with, the regenerated version of the content is performed in response to receiving an indication from the content provider approving of the recommendation.

In some embodiments, inputting, to the second machine learning model, the data indicating the at least a portion of the content and the data indicating the identified portion of the content is further performed based on determining that at least one of the plurality of reactions indicates that the content comprises data that is false or offensive. In some embodiments, inputting, to the second machine learning model, the data indicating the at least a portion of the content and the data indicating the identified portion of the content is further performed based on determining that a number of reactions having a negative sentiment exceeds a number of reactions having a positive sentiment, or that no reactions having a positive sentiment are present (or that a number of reactions having a positive sentiment are below a threshold).

In some embodiments, the system(s) may be configured to determine a first user is currently viewing the content on the social media platform via a first computing device, and that a second user is currently viewing the content on the social media platform via a second computing device. The system(s) may be configured to identify first user preferences associated with the first user, and identify second user preferences associated with the second user. The second machine learning model may be configured to regenerate the content by regenerating the content as first modified content, based at least in part on the first user preferences, and regenerating the content as first modified content based at least in part on the second user preferences. The system(s) may cause the content on the social media platform to be replaced with (or otherwise modified) or supplemented with the regenerated version of the content by causing the content to be replaced with (or otherwise modified) or supplemented with the first modified content at the first computing device of the first user, and causing the content to be replaced with (or otherwise modified) or supplemented with the second modified content at the second computing device of the second user.

In some embodiments, the social media platform is a first social media platform, the plurality of reactions is a first plurality of reactions, and the plurality of users is a first plurality of users. The system(s) may be configured to determine the content is being displayed on a second social media platform, and identify a second plurality of reactions to the content from a second plurality of users of the second social media platform. The system(s) may be configured to input, to the first machine learning model, data indicating the second plurality of reactions, and receive, as output from the first machine learning model, sentiment data for each of the second plurality of reactions. The system(s) may be configured to, in response to determining, based on the sentiment data for each of the second plurality of reactions output from the first machine learning model, that none of the second plurality of reactions have a negative sentiment or that fewer than a threshold number of the second plurality of reactions have a negative sentiment, maintain the content on the second social media platform.

In some embodiments, the system(s) may be configured to provide for display the plurality of reactions, and, based on the sentiment data for the plurality of reactions, modify the display of the plurality of reactions to group a first subset of the plurality of reactions having a positive sentiment together; group a second subset of the plurality of reactions having a negative sentiment together; and group a third subset of the plurality of reactions having a neutral sentiment together.

In some embodiments, the content comprises text data; the second machine learning model is a large language model; the data indicating at least a portion of the content, input to the second machine learning model, comprises at least a portion of the text data; and the data indicating the identified portion of the content comprises an indication of an identified portion of the text that is determined and input to the second machine learning model, based on the sentiment data, to be modified or omitted in the regenerated version of the content; and a command requesting the text data to be regenerated based on the identified portion of the text is input to the second machine learning model. In some embodiments, for cases where the system(s) is regenerating an image (or audio), the second machine learning model may be a multi-modal model.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative system for regenerating content based on determined reactions to the content, in accordance with some embodiments of this disclosure.

FIG. 2 shows an illustrative system for regenerating content based on determined reactions to the content, in accordance with some embodiments of this disclosure.

FIG. 3 is a flowchart of a simplified system architecture of content being exchanged from the content platform and content creator.

FIG. 4 shows a block diagram of a content distribution ecosystem, in accordance with some embodiments of this disclosure.

FIG. 5 is a flowchart of a detailed illustrative process for analyzing and correcting content from a content platform, in accordance with some embodiments of this disclosure.

FIG. 6 is a flowchart of a detailed illustrative process for analyzing and correcting content from a content platform, in accordance with some embodiments of this disclosure.

FIGS. 7A-7C shows block diagrams of illustrative trained machine learning models, in accordance with some embodiments of this disclosure.

FIGS. 8A-8C shows block diagrams of illustrative untrained machine learning models, in accordance with some embodiments of this disclosure.

FIGS. 9-10 show illustrative devices and systems for regenerating content based on determined reactions to the content, in accordance with some embodiments of this disclosure.

FIG. 11 shows an illustrative flowchart for regenerating content based on determined reactions to the content, in accordance with some embodiments of this disclosure.

FIG. 12 shows an illustrative display in which reactions to content are ordered based on sentiments of the reactions in relation to the content, in accordance with some embodiments of this disclosure.

### DETAILED DESCRIPTION

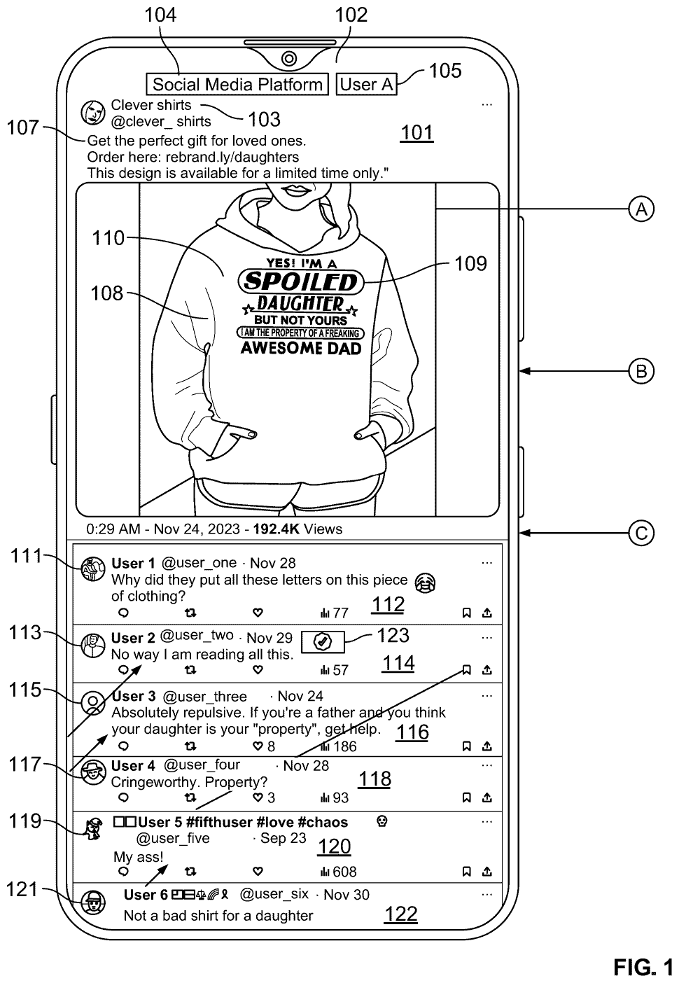

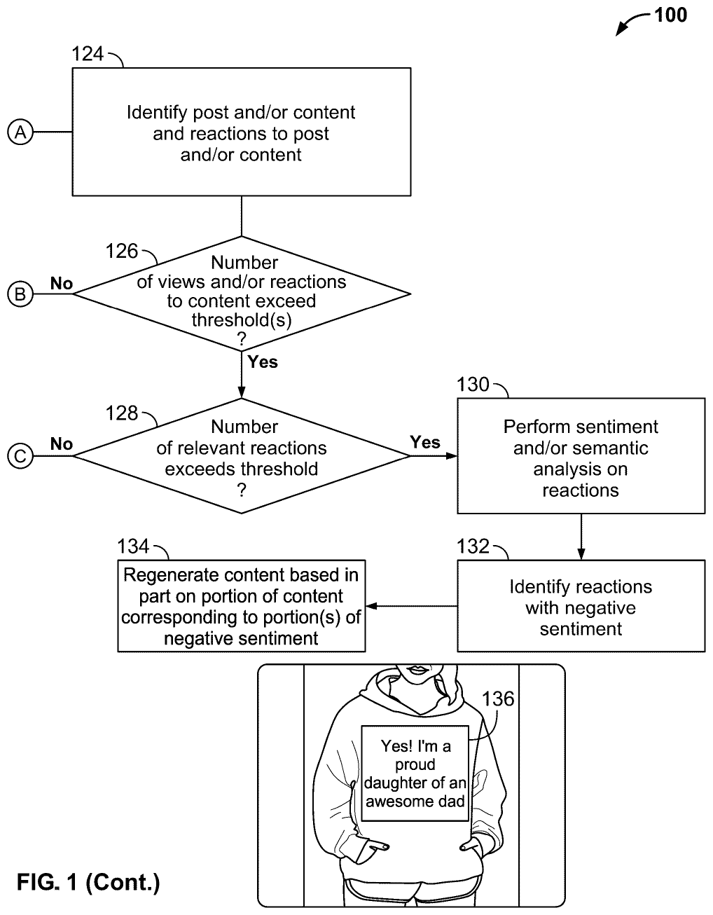

FIG. 1 shows an illustrative system 100 for regenerating content based on determined reactions to the content, in accordance with some embodiments of this disclosure. System 100 comprises computing device 102, which provides user interface 101 to a user 105 accessing a platform 104 (e.g., a social media platform, an advertising platform, a news platform, a media platform, a video platform, a restaurant/travel review platforms, a mapping platform that lists businesses where businesses already advertise, any platform capable of hosting, distributing and/or providing a content item and receiving feedback thereon, or any other suitable platform, website, or application, or any suitable combination thereof). User interface 101 comprises content 108 displayed to one or more users of platform 104. It should be noted that “based on” and “based at least in part on” are used interchangeably herein, and that as used herein, performing a particular action or function (or obtaining an attribute or result) “based on” or “based at least in part on” a particular criterion is not intended to limit such action, function, attribute, or result to be performed or obtained solely on the basis of such particular criterion.

In some embodiments, content 108 may be an image, a video, advertisement, promoted content, supplemental content, three-dimensional (3D) content, two-dimensional (2D) content, or any other suitable content, or any combination thereof. Content 108 may comprise visual elements, textual elements, audio elements, or any other suitable elements, or any combination thereof. In some embodiments, content 108 may be an advertisement provided via a corporate profile of a company 103 (e.g., Clever Shirts) on social media platform 104 for the purpose of promoting the company's brand, services and/or products.

In some embodiments, computing device 102 may comprise or correspond to a headset; a mobile device such as, for example, a smartphone or tablet; a laptop computer; a personal computer; a desktop computer; a smart television; a smart watch or wearable device; smart glasses; a stereoscopic display; a wearable camera; extended reality (XR) glasses; XR goggles; a near-eye display device; or any other suitable user equipment or computing device; or any combination thereof. XR may be understood as virtual reality (VR), augmented reality (AR) or ‘mixed reality (MR) technologies, or any suitable combination thereof. VR systems may project images to generate a 3D environment to fully immerse (e.g., giving the user a sense of being in an environment) or partially immerse (e.g., giving the user the sense of looking at an environment) users in a 3D computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

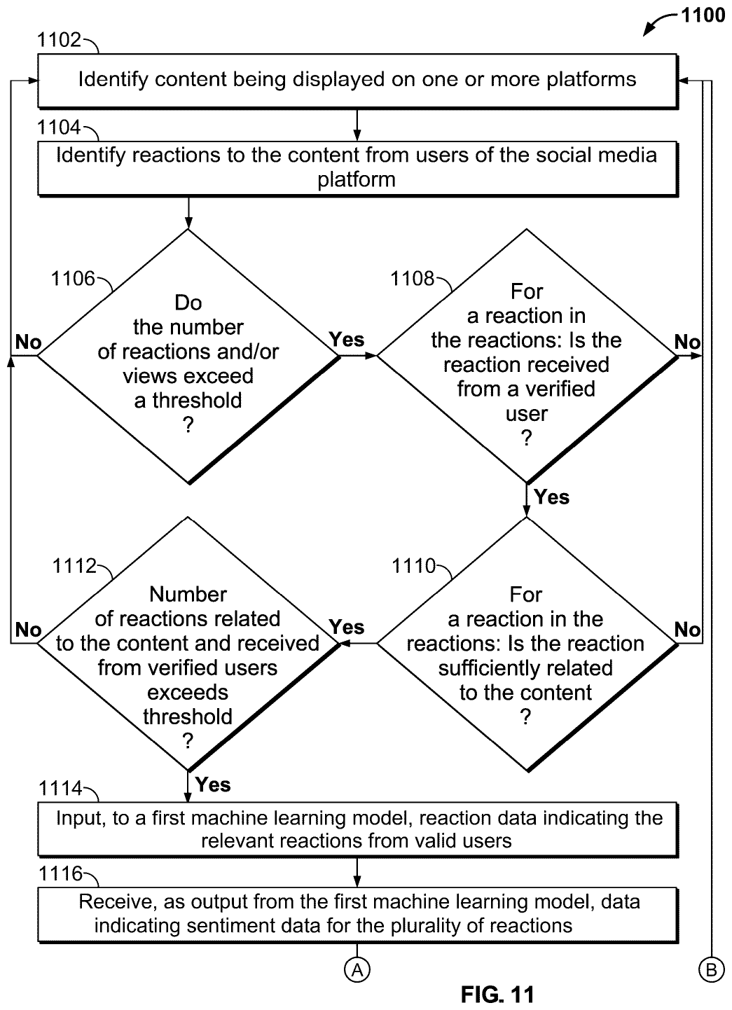

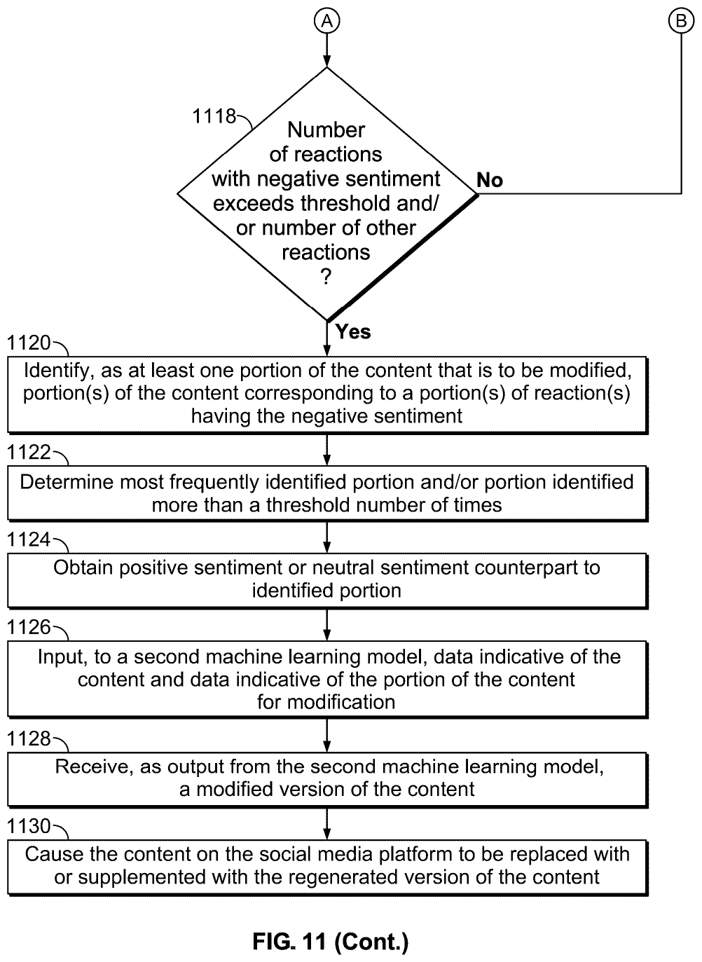

In some embodiments, system 100 may be a content regeneration system (referred to below as “the system”), which may comprise or correspond to a content regeneration application, which may be executed at least in part on computing device 102 and/or at one or more remote servers (e.g., server 1102 of FIG. 11) and/or at or distributed across any of one or more other suitable computing devices, in communication over any suitable number and/or types of networks (e.g., the Internet). The content regeneration application may be configured to perform the functionalities (or any suitable portion of the functionalities) described herein. In some embodiments, the content regeneration application and/or the system may be a stand-alone application, or may be incorporated as part of any suitable application or system, e.g., social media platform; an advertising platform; a content creation and/or content editing application; a collaborative design tool; a content provider application; an XR application; a social networking application; a content acquisition, recognition and/or processing application; a machine learning model or AI system; or any other suitable application or system; or any combination thereof; and/or may comprise or employ any suitable number of displays, sensors or devices such as those described in FIGS. 1-12, or any other suitable software and/or hardware components; or any combination thereof.

In some embodiments, the system may receive interactions with, and/or reactions 112, 114, 116, 118, 120, and 122 to, content 108 from users 111, 113, 115, 117, 119, and 121 on platform 104. It should be appreciated that the system may identify and analyze any suitable number of reactions to content 108. In some embodiments, reactions 112, 114, 116, 118, 120, and 122 may comprise comments (e.g., text, images, video, emojis, soundmojis, and/or audio responding to or making an observation about content 108 and/or other reaction(s) to content 108), likes of content 108 and/or other reaction(s) to content 108, dislikes of content 108 and/or other reaction(s) to content 108, reposts of content 108 and/or other reaction(s) to content 108, shares of content 108 and/or other reaction(s) to content 108, saves of content 108 and/or other reaction(s) to content 108, downloads of content 108 and/or other reaction(s) to content 108, views of content 108 and/or other reaction(s) to content 108, and/or any other suitable interaction or reaction in relation to content 108 or reactions to content 108, or any combination thereof. In some embodiments, views of content 108, without more, may or may not be considered an interaction or reaction to content 108.

In a non-limiting example, in the example of FIG. 1, the system may identify content 108. In a non-limiting example, the system may determine that content 108 comprises a media portion 110 of a white sweatshirt being modeled on a woman, and text portion 109 (e.g., on the sweatshirt itself). Text portion 109 comprises text of “Yes! I'm a spoiled daughter but not yours I am the property of a freaking awesome dad.” Content 108 may be included in a post 107 by a user 103 (e.g., associated with a company promoting the sweatshirt) and post 107 by include text, e.g., a hyperlink to a site at which the sweatshirt shown in content 108 may be purchased.

At 124, the system may identify reactions 112, 114, 116, 118, 120, and 122 to content 108 from users 111, 113, 115, 117, 119, and 121, respectively. For example, the system may identify reaction 114 comprising the text “Why did they put all these letters on this piece of clothing?” from user 111, and a laughing face emoji (posted by a user with the user name “User 1,” “User 2,” etc.); reaction 112 comprising the text “No way I am reading all this” from user 113 (posted by a user with the user name “User 2”); reaction 116 comprising the text “Absolutely repulsive. If you're a father and you think your daughter is your ‘property,’ get help” from user 115 (posted by a user with the username “User 3”); reaction 118 comprising the text “Cringeworthy. Property?” from user 117 (posted by a user with the username “User 4”); reaction 120 comprising the text “My ass!” from user 119 (posted by a user with the username “User 5”); and reaction 120 comprising the text “Not a bad shirt for a daughter” from user 121 (posted by a user with the username “User 6”). For example, the system may determine, based on the reactions, that certain parts of content 108 hit a nerve with its audience, e.g., some comments are related to the length of the text of content 108, and some took issue with the words on the image in terms of appropriateness, which the system may determine might potentially impact the sales of the product that is being advertised.

At 124, the system may identify a structure of post 107 and/or a structure of content 108. For example, for post 107 comprising content 108, the system may identify the user name of a user 103 of the poster of post 107 (e.g., “Clever shirts,” which may be a company or advertising brand associated with content 108); a user handle (e.g., @clever_shirts) associated with user 103; a title and/or description of user 103 (e.g., metadata indicating a company affiliation of user 103); whether the post is public or private or what other platforms the post is cross-posted to; text portion 109 of post 107; media portion 110 of post 107; a date of post 107 (e.g., Nov. 24, 2023); a count of views, likes, comments, reposts, and/or saves; and/or a count of any other suitable data or interaction related to post 107 and/or content 108.

In some embodiments the system may determine whether one or more of users 111, 113, 115, 117, 119, and 121 are valid or verified users. For example, the system may analyze a number of posts associated with a profile of a particular user, a user name of the profile, an amount of time the profile has been active, whether other posts of the profile have been flagged, content of the instant reaction or historical reactions, feedback of other users with respect to the particular user, whether the particular user is associated with a particular status (e.g., a blue checkmark 123, or other indication that the user is valued or legitimate user of platform 104 or is verified by platform 104), whether the particular user has a track record of valid feedback, and/or use any other suitable data, to determine whether each of users 111, 113, 115, 117, 119, and 121 is a valid or verified user. This determination may be platform independent or platform dependent, e.g., a blue checkmark or longevity of the user on the platform and/or other platforms, and/or indication of whether their reviews have received favorable response (e.g., thumbs up on their comments or posts). In some embodiments, whether a user has a profile picture (instead of having a blank or empty portion where a profile picture should be) may weigh in favor of the user being considered a verified or valid user. In some embodiments the system may determine whether one or more of users 111, 113, 115, 117, 119, and 121 are valid or verified users based on whether an IP address of the user providing the feedback/reaction is from a questionable location (e.g., a geographic location known to be associated with hackers or bots), and/or based on whether the user is leveraging a virtual private network (VPN). For example, if the user is determined to be posting the reaction from a questionable location and/or using a VPN, this may weigh in favor of the user not being considered a valid or verified user.

In some embodiments, if the system determines that a user is not a verified or valid user, that user's reaction to content 108 may be discarded and not factored into further analysis performed by system 100 (or less heavily weighted than reactions from other verified or valid users to content 108). This may help filter out reactions from fake profiles and/or “bots,” which may exist on platforms to a certain degree, that pollute responses with bogus and/or useless feedback. For example, reaction 120 associated with user 119 comprising the text “My ass!” may be identified as an invalid or unverified account (e.g., likely to be a bot) based on the techniques described above, and thus may be isolated from the other reactions and not taken into account during subsequent processing steps (e.g., excluded from steps 126, 128, 130, 132, and 134), so that processing is performed on a limited set of reactions (e.g., comments or other interactions) from valid accounts, as shown below:

valid_reactions to content 108 = all reactions to content 108 − reactions
of non-verified_accounts to content 108

In some embodiments, any reactions or comments from the original poster (e.g., user 103) may be identified (e.g., based on comparing the user name of the comments or reactions to the user name associated with initially posted content 107) and may be excluded from subsequent processing steps (e.g., excluded from steps 126, 128, 130, 132, and 134), as the original poster's reactions may be biased and may not be reflective of the community's genuine reactions towards content 108. As shown below:

user_reactions = valid reactions to content 108 − reactions to content
108 from original_poster

At 126, the system may determine whether a number of views of, and/or a number of reactions to, content 108 exceeds one or more thresholds. For example, prior to generating a regenerated version 136 of content 108 (e.g., automatically without user input, or based at least in part on received user input), the system may perform one or more threshold determinations (e.g., the determination of whether the user is a verified user, which may occur as part of step 124,), in an effort to conserve computing and/or networking resources. For example, the system may determine whether post 107 and/or content 108 received a relatively high number of views (and/or a high number of reactions, such as, for example, reposts, comments, likes, dislikes saves, or any other suitable reaction, or any combination thereof). For example, the system may determine whether a number of views and/or reactions exceeds one or more thresholds. In some embodiments, the number of views and/or number of reactions may be pulled from social media post statistics. In some embodiments, the social media post statistics may be part of a data management platform implemented by the system. In other embodiments, the social media post statistics are accessed by the system via an API.

In some embodiments, he threshold may be a default value or a dynamic value, and may be the same or different for certain platforms, certain entities associated with content 108, certain products or services (or types or categories thereof) depicted or being promoted in content 108, and/or based on historical trends of viewership of similar types of content (e.g., having been regenerated from its original form by the system). In some embodiments, a threshold for a number of views may be higher than a threshold for a number of reactions. This may help ensure that computing resources for regenerating content are allocated to posts and/or content that are sufficiently popular or are generating a sufficient amount of interest to make the use of such resources worthwhile, e.g., having an aggregate high number of views, reactions, reposts, saves, likes, or any suitable combination thereof.

In some embodiments, the system may perform a threshold determination as toa ratio of an amount of feedback via reactions to total views. For instance, as a non-limiting example, if content 108 has been viewed 10,000 times (on platform 104 and/or other platforms), and if the number of reactions exceeds 30, the system may determine to proceed with generating a regenerated version 136 of content 108. For example, this ratio may be based on the inference that since companies may pay $3-10 per 1000 impressions (CPM), this means they have paid more than $30 for an advertisement and if they are getting feedback from 30 people who are taking the time to type an input, that this input may be taken into account to help protect a company's return on investment. In some embodiments, the ratio value may be dynamically determined or may be a default value, and/or may depend on a type of content and/or historical viewing data and/or historical interaction data with the content or content type. In some embodiments, the ratio may be set or dictated by the owner of the social media profile associated with post 107 (e.g., a brand, vendor, company, etc.).

In some embodiments, any views or reactions determined to be from an invalid or unverified user (e.g., reaction 120) may not be included in the count of the number of views and/or the number of reactions to content 108. In some embodiments, any views or reactions determined (e.g., at 124) not to be sufficiently related to content 108 or one or more reactions thereto may not be included in the count of the number of views and/or the number of reactions to content 108. Alternatively, in some embodiments, reactions that are determined to be from unverified users and/or that are determined not to be related to content 108 may be included in the number of views and/or the number of reactions to content 108, or 126 may be re-performed, e.g., comparing a number of reactions that are from verified users and that are related to content 108 to a threshold, prior to performing subsequent processing.

At 128, the system may determine whether subject matter of one or more of reactions (e.g., 112, 114, 116, 118, and 122 determined to be from verified users) are sufficiently related to content 108. For example, the system may compare one or more portions of reactions 112, 114, 116, 118, and 122 to one or more portions of content 108, to determine whether a particular reaction is relevant to subject matter indicated by content 108, e.g., if a threshold number of words of the text of a particular reaction match words of text portion 109 of content 108, and/or if a similarity score between an image, video, meme, GIF, or emoji of a particular reaction sufficiently matches or has a sufficient overlap with media portion 110 that exceeds a threshold.

In some embodiments, the post data is vectorized (e.g., image data and text data are put in a data vector) into a post vector and the responses are vectorized (e.g., comment data are put into distinct data vectors) into correlating response vectors. The system may conduct a regression analysis (e.g., using linear regression, Multivariate Multiple Regression, etc.), distance analysis (e.g., using linear algebra distance algorithms such as Euclidian distance), or a non-linear data analysis (e.g. using a cosine similarity measure), on the vectorized post data and the vectorized responses to determine a variance level between the post vector and response vectors. The system may use the variance levels to determine similarity between a response to post 107.

In some embodiments, the system may analyze content 108 and/or post 107, to determine whether content 108 and/or post 107 comprises an image (e.g., emoji or other image), video, text, audio, or any other suitable data, or any combination thereof. For example, if the system determines content 108 and/or post 107 comprises text, the system may build a bag of words (or any other suitable model or data structure) from the full text of the post:

Post_bag_of_words = (PostWord 1, AdWord 2, ..................
PostWord N)

In some embodiments, the bag of words may be structured as an array, a stack, a heap, a list, a collection of vectors, any other data structure, or any combination thereof. As another example, if the system determines content 108 and/or post 107 comprises audio, properties of the audio (e.g., frequency, loudness, wavelength, amplitude, pitch, velocity, envelope, timbre, any other audio properties, or any combination thereof) may be analyzed and stored if the audio is detected to be either speech or non-speech. In some embodiments, the system may store the output of speech-to-text processing of content 108 and/or reactions thereto in the respective bag of words on in another data structure. The system may, based on determining the audio is speech, use a speech-to-text algorithm to extract text corresponding to the speech, and add words of the extracted text to the bag of words:

```
  Post_audio_propertiesₜᵢₘₑ (frequency, loudness, wavelength, amplitude
pitch, velocity, envelope, timbre)
  Post_bag_of_words = Post_bag_of_words + (AudioWord₁,
AudioWord₂, ... AudioWord_{N}
```

As another example, if the system determines content 108 and/or post 107 comprises at least one image, the system may segment the objects on the image and use computer vision and/or object recognition techniques (e.g., semantic segmentation) to identify objects, people, locations, and/or any other suitable portions of the at least one image. If the image has overlays on it (e.g., text and/or emojis), the system may extract and identify such text and/or text corresponding to the emojis (e.g., via emoji to text trained model and/or lookup) and add the extracted text to the bag of words:

Image_Objects = (ImageObject₁, ImageObject₂, ... ImageObject_{N})
Post_bag_of_words = Post_bag_of_words + (ImageText₁,
ImageText₂, ... ImageText_{N})
Post_bag_of_words = Post_bag_of_words + (EmojiText₁,
EmojiText₂, .. .EmojiText_{N})

In some embodiments, the system may perform the segmentation (e.g., semantic segmentation and/or instance segmentation) on the at least one image to identify, localize, distinguish, and/or extract the different objects, and/or different types or classes of objects, or portions thereof. For example, such segmentation techniques may include determining which pixels (or voxels) in the image belong to a particular object. Any suitable number or types of techniques may be used to perform such segmentation, such as, for example: machine learning. computer vision. object recognition. pattern recognition. facial recognition. image processing. image segmentation. edge detection. color pattern recognition, partial linear filtering, regression algorithms, and/or neural network pattern recognition, or any other suitable technique, or any combination thereof. In some embodiments, the system may identify objects by extracting one or more features for a particular object, and comparing the extracted features to those stored locally and/or at a database or server storing features of objects and corresponding classifications of known objects.

As another example, if the system determines content 108 and/or post 107 comprises video, such as, for example, an animation or short form video, or a hyperlink to a video, the system may perform analysis of frames of the video, e.g., using the segmentation techniques described above. The system may record timestamps of when certain video frames appeared in the video.

Video_Objects = (VideoObject [_{1, video}_{_{—}}_{frame}], VideoObject
[_{2, video}_{_{—}}_{frame}], ... VideoObject [_{N, video}_{_{—}}_{frame}])

In some embodiments, at 128, the system may employ a graph convolutional network (GCN), a large language model (LLM), an audio model, and/or any other suitable model or computer-implemented technique, or any combination thereof, in determining whether the reactions (e.g., 112, 114, 116, 118, 120, and/or 122) are sufficiently relevant to content 108 or post 107 (or any combination thereof), and/or to understand the context of feedback that users (e.g., users 111, 113, 115, 117, 119, 121) are providing, and/or in performing sentiment analysis at 130. For example, the system may perform semantic analysis of content 108, and reactions of users to the content 108, and compare the results of such analyses, to determine a degree of relevancy between the content 108 and each respective reaction to content 108. In some embodiments, a single model that can process both text, image, audio and/or video may be used rather than multiple models.

In some embodiments, the LLM (referenced above, which may be used as part of step 128 as part of a second machine learning model and/or multi-modal language, visual, and audio model) may be configured to generate text in desired formats using text prompts, and/or visual elements (e.g., by visually inspecting pixels or voxels for use in a neural network), as input, and/or other modalities. Since reaction posts may have multi-modal content, the system may use the techniques described herein to perform multi-modal analysis. For example. The system may also use a muti-modal machine learning model that takes in input of multiple data types such as text, audio, images, and videos, and outputs an analysis of content 108, and/or the reactions to content 108.

At 128, the system may determine if each respective comment or reaction is related to post 107 and/or content 108 at all. If a comment or reaction is determined not to be related to content 108, the system may tag and remove the irrelevant comments from the final comment list. In some embodiments, whether each comment or reaction is relevant to content 108 may be performed by inputting a prompt (e.g., “Is this comment related to the post?”) for each reaction or comment through the LLM. In some embodiments, 128 and 130 may be performed simultaneously or in parallel or in combination, e.g., to quickly zero in on negative reactions to content 108. To perform the processing at 128 and/or 130, the system may have access to both the post comprising content 108 and the comment or reaction list at the same time. The analysis may be multi-modal, e.g., after the NLP analysis from LLM, visual and audio analysis will be performed by a visual and audio model, respectively (or by a combined model). In some embodiments, access to these models can be achieved through API calls with the corresponding parameters such as text, image, video frame, or any other suitable parameters, or any combination thereof:

Comments_{PostRelated} = User_Comments − User_Comments_{NotPost}_{_{—}}_{Related}

At 130, the system may run the remaining comments (e.g., determined to be related to content 108 and received from a verified user), through the LLM to perform sentiment analysis, and/or employ any other suitable computer-implemented technique (e.g., NLP, machine learning, comparison of portions of a reaction to text or images in a database with defined sentiment classification) to generate sentiment classifications for the reactions (e.g., reactions 112, 114, 116, 118, and 122), such as, for example, a classification of positive, neutral, or negative text inputs. For example, the system may provide the LLM with input of “Classify if this comment is positive, neutral or negative.” In some embodiments, for the LLM to operate on the comments and have access to appropriate data sharing to perform the operation, platform and/or social media credentials and/or LLM API keys may have been exchanged, or platform 104 may runs the classification itself within its own ecosystem. The LLM may perform a classification algorithm on the comment set such as that:

[Comments_{Positive}, Comments_{Neutral}, Comments_{Negative}] =
LLM_{—}_{Classification} (User_Comments_{Post}_{_{—}}_{Related})

For example, the system may determine that reaction 112 “Why did they put all these letters on this piece of clothing?” from user 111, which includes a laughing face emoji, has, at best, a neutral sentiment in relation to content 108, or has a negative sentiment in relation to content 108. The system may determine that reaction 112 comprising the text “No way I am reading all this” from user 113 has a negative sentiment in relation to content 108, and that reaction 116 comprising the text “Absolutely repulsive. If you're a father and you think your daughter is your “property,” get help” from user 115 has a negative sentiment in relation to content 108. The system may determine that reaction 118 comprising the text “Cringeworthy. Property?” from user 117 has a negative sentiment in relation to content 108. In some embodiments, a sentiment for reaction 120 may not be determined, based in part on reaction 120 having been determined to be from an unverified user or unrelated to content 108. The system may determine that reaction 122 comprising the text “Not a bad shirt for a daughter” received from user 121 has a positive sentiment in relation to content 108.

At 132, the system may determine that reactions 112, 114, 116, and 118 each have a negative sentiment in relation to content 108. In some embodiments, the system may, at this point, operate only on reactions (e.g., comments) that are deemed to have a negative sentiment in relation to content 108. The system may identify and parse text of 112, 114, 116, and 118 having the negative sentiment in relation to content 108 (e.g., extract the text of the post itself, obtain transcribed text from audio of the post, and/or obtain one or more natural language descriptions of images or video frames included in or referenced by the reaction). The one or more natural language descriptions may describe a particular reaction as a whole, and/or any suitable portion(s) or subset(s) thereof, and may be obtained using any suitable computer-implemented technique (e.g., one or more machine learning models, and/or heuristic techniques).

In some embodiments, if the system determines that a number of positive (and/or neutral) reactions exceeds the number of negative reactions (or the system does not identify any negative reactions), the system may determine that the content need not be regenerated. just on the sole number of reaction. In some embodiments, the system may determine whether content is to be regenerated based on a ratio of positive reactions to negative reactions, e.g., the system may determine to regenerate content if a number of negative reactions exceeds the number of positive and/or neutral reactions by a certain threshold amount (e.g., twice as many negative reactions as positive and/or neutral reactions may be deemed a sufficient amount to proceed with regenerating the content).

The system may determine whether the parsed text also appears in content 108. For example, the system may determine that the word “property” appears in reactions 116 and 118 having a negative sentiment, and also appears in text of the sweatshirt in content 108. For example, the system may parse the words that appear in the comments to check whether they appear in the aggregate bag of words, as described above, associated with content 108.

Content Comments_{Negative} = Check (Content_Bag_Of_Words,
Comments_{Negative})

The system may mark one or more portions or words (e.g., “property”) appearing in one or more of the reactions and the content 108. For example, such marking may be based on the system determining whether a particular portion (e.g., the word “property”) appears in a majority of the reactions, a threshold number of the reactions having the negative sentiment, or in more reactions than any other portion of content 108. In some embodiments, if a number of reactions having a positive sentiment and/or neutral sentiment is greater than a number of reactions having a negative sentiment (and/or aggregate weights assigned to the positive sentiment and/or neutral sentiment reactions exceed aggregate weights assigned to the negative sentiment reactions), the system may decline to regenerate content 108.

In some embodiments, to analyze audio of content 108 and/or reactions thereto, the system may employ an audio model (e.g., a generative adversarial network model such as AudioCraft, or any other suitable machine learning model, or custom implementations of a machine learning model, or any combination thereof). In some embodiments, to analyze images of content 108 and/or reactions thereto, the system may employ visual model (e.g., GPT-4 with vision, or GPT-4V, or any other suitable machine learning model, or custom implementations of a machine learning model, or any combination thereof). In some embodiments, such multimedia models may be passed the original post for their analysis. In some embodiments, the analysis for a particular reaction may comprise and/or conclude based on determining that one or more portions (e.g., a text portion and/or media portion) of the particular reaction to content 108 corresponds to, matches, or is otherwise relevant to one or more portions (e.g., text portion 109 and/or a media portion 110) of content 108. Based on such determination, the system may generate a set of metadata related to content 108 with respect to one or more of the reactions having the negative sentiment. In some embodiments, the system may determine whether one or more of the reactions having a negative sentiment received a relatively high number of likes or other engagement (e.g., further comments). For example, the system may determine whether the number of likes or other engagement exceeds a threshold amount, or exceeds likes or other engagement of other reactions to content 108 by a threshold amount, or has the most likes or other engagement of any of the reactions to content 108. The system may assign a higher weight to reactions having a negative sentiment that have the relatively large number of likes or other engagement. For example, reaction 116 may be weighted more heavily than other reactions as it has more likes than any of the other reactions. On the other hand, while “clothing” in reaction 112 is related to the sweatshirt of content 108, such reaction has not received any or minimal likes or engagement, and thus the portions of reaction 112 may be weighed less heavily than other reactions.

Based at least in part on the multi-modal analysis performed at 132, the system may generate a mapping table of fragments of content 108 that has an association with one or more of the negative reactions:

Content Comments_{Negative} [i] −> Content_Bags_Of_Words (j)
Content Comments_{Negative} [j] −> Content_Image_Object (v)
Content Comments_{Negative} [k] −> Content_Video_Object (u,
[video_frame [z])
Content Comments_{Negative} [m] −> Content_Audio (w, [audio_frame [y])

In some embodiments, for audio portions and video frames the Content Comments_{Negative} [n] may apply to one or more portions or frames or even all portions or frames. For instance, if content 108 includes a video, and a comment on content 108 includes a negative observation about a particular voice present in the video, the system may determine which audio portions in content 108 the comment regarding the particular voice is applicable to, by analyzing each audio portion of the video.

At 134, the system may, based at least in part on determining that one or more of the reactions to content 108 have a negative sentiment in relation to content 108, generate a regenerated version 136 of content 108, e.g., depicting the same white sweatshirt of content 108, but with the text “Yes! I'm a spoiled and proud daughter of an awesome dad,” which the system may determine is likely to be less offensive or less controversial than the original text on the sweatshirt in content 108. For example, based on the processing performed at 130 and 132, the system may identify one or more portions (e.g., the word “property”) of the one or more reactions (e.g., reactions 116 and 118) having a negative sentiment towards content 108 that corresponds to one or more portions of content 108 (e.g., the word “property” being present in “I am the property of a freaking awesome Dad”) in text portion 109 of content 108. The system may issue a prompt to an AI model (e.g., an LLM, GPT-4V, or any other suitable machine learning model, or custom implementations of a machine learning model, or any combination thereof) as to what would be a neutral (or positive) counterpart of the identified portion (e.g., the word “property”).

For example, if content 108 is only text-based, or for a portion of content 108 that is text-based, the system may cause the identified portion (e.g., the word “property” and/or the phrase “property of a freaking” which may correspond to Content Comments Negative [i]) to be replaced with a positive counterpart or otherwise positive term conveying a similar message but in a more tactful manner (e.g., replace “property” and “freaking” with “proud daughter”), and content 108 may be converted to new variant 136 with the new positive (or neutral) connotation portion. In some embodiments, the prompt to the LLM may be structured in one of the following forms: “In [content 108] replace the negative term Content Comments Negative [i] with something neutral/positive.”

In some embodiments, a prompt to the LLM may be in the form of attention-interest-desire-action, e.g., to request the LLM to replace the property word with an equivalent word that has positive connation, where the end result of the word still fits into the same sentence context, as shown below. Similarly, a prompt to the LLM may be in the form of situation-action-result, or a problem-action-result format.

Content Comments_{Positive}_{_{—}}_{Modification} [i] = LLM (positive prompt,
Content Comments Negative [i])

In some embodiments, the system may receive input specifying, or automatically specify, a desired output length, which may or may not be equal to a number of words or characters (and/or may or may not comprise a same amount of imagery) as the portions of content 108 being replaced. In some embodiments, if the system is not able to locate an equivalent word or other portion, the output length may be extended to accommodate multiple portions to replace the identified problematic portion. In some embodiments, if no equivalent can be found, the offending word can be removed from content 108 and content 108 may be regenerated (e.g., using a generative AI model). In some embodiments, if the LLM or other machine learning model, which may be used in relation to step 134, is not general purpose, but more vertical specific, further embeddings may be provided such as “As an advertisement specialist of product X” as preambles.

In some embodiments, the system may take into account reactions relating to a length of one or more portions of content 108. For example, the system may determine that the reactions 112 and 114 of “Why did they put all these letters on this piece of clothing?” and “No way I am reading all of this,” indicate that one or more portions (e.g., text portion 109) is excessively long in content 108. Based at least in part on this determination, the system may cause the corresponding portion in regenerated version 136 of content 108 to be shorter. For example, “Yes! I'm a proud daughter of an awesome dad” contains fewer characters than “Yes! I'm a spoiled daughter but not yours I am the property of a freaking awesome dad.”

In some embodiments, the system may determine that the negative sentiment analysis marked more than a word (or more than one other portion) of content 108 as portions of content 108 likely driving the negative sentiment, e.g., the system may mark multiple and sequential words as potential words that are at fault. For example, the system may invoke the LLM (or other suitable machine learning model or other suitable computer-implemented technique) with specific instructions to generate new text excluding the identified multiple and sequential words (or other multiple portions), which may be similar to including the words in a negative prompt. In some embodiments, a final word replacement and/or other modifications to content 108 in generating regenerated version 136 of content 108 may be replicated in the Content_bag_of_words referenced above.

In some embodiments, the system may determine that a specific portion of text of one or more of the reactions to content 108 corresponds to a specific portion of audio, image, text or video frame of content 108. For example, if a reaction to content 108 was “Why can't we see the daughter's face?,” the system may determine that that a suitable modification to content 108 when regenerating content 108 would be to generate a full view of face of the model wearing the sweatshirt (e.g., by retrieving an uncropped version of the image, or outpainting or generating the remaining portion of the face of the girl using an AI model, for inclusion in the regenerated version 136 of content 108). As another example, the system may prompt the generative model to replace the specific portion of audio, image, text or video frame of content 108 with a positive or neutral counterpart, resulting in a modified content (e.g., modified image, text, audio and/or video) with respect to the original content 108. In some embodiments, such generative model may be a general-purpose model fine-tuned on the product being advertised in content 108. For example, a new image may be generated by a text-to-image model that includes a low-rank adaptation (low-rank adaptation of large language models or LoRA, or any other suitable machine learning model, or custom implementations of a machine learning model, or any combination thereof) of a generative model, which may have been built and/or trained using images of the product or service being advertised or otherwise shown:

```
  a. content_image_object (v_modified) = generative_vision_model
(positive_prompt, content_image_object (v))
  b. content_video_object = (video_frame_modified[z] =
generative_vision_model (positive_prompt, content_video_object
(u, [video_frame [z]))
  c. content_audio (audio_frame_modified[y]) =
generative_audio_model (positive_prompt, content_audio (w,
[audio_frame [y]))
```

In some embodiments, visual and/or audio models may be provided with a specific offending word (e.g., “property”), identified using the described techniques, and at least a portion of the relevant content (e.g., image, text, video, and/or audio frame) as inputs. In some embodiments, further clarification to the model can be provided with a prompt such as, for example, changing color, framerate, or resolution or replicating certain frames, or any other suitable instruction, e.g., if the user comments made a specific reference to it (e.g., as detected by the LLM). In some embodiments, the one or more machine learning models, which may be used to generate the regenerated version 136 of content 108, may be executed for every word (or every other suitable portion) that is within the mapping list of the mapping table of fragments of content 108 described above. In some embodiments, in a checksum process, the final version of the regenerated version 136 of content 108 may be input or refined using the LLM, vision and/or audio models to help facilitate cohesion among the portions of the regenerated version 136 of content 108.

In some embodiments, to help accelerate a process of correcting content 108, the system may feed the negative comments (e.g., reactions 112, 114, 116, and 118) to the LLM to help generate a new script or natural language description of the corrected content; the audio model may use text-to-speech techniques to generate new audio portions, or modify the existing audio portions, based on the feedback gleaned from the reactions to content 108; and the visual generative models may modify the visual content, e.g., all in one shot. In some embodiments, the cohesion checksum process may also be employed.

In some embodiments, the regenerated version 136 of content 108 may be assigned new metadata indicating that it is a new variant of original content 108. On content platform 104, content 108 may be refreshed instantaneously, and/or may be visually marked as a new version of content 108, e.g., the mapping with the original version of content 108 may also be shown, if desired. In some embodiments, now out-of-date comments, due to the modified content, may be linked to the older version of the content.

The system may, based at least in part on determining that one or more of the reactions to content 108 have a negative sentiment in relation to content 108, generate a regenerated version 136 of content 108, e.g., depicting the same white sweatshirt of content 108, but with the text “Yes! I'm a proud daughter of an awesome dad,” which the system may determine is likely to be less offensive or less controversial than the original text on the sweatshirt in content 108, and which targets for modification specific portions of content 108 identified as likely to be causing the negative sentiment, to fine-tune content 108 while preserving the original structure and/or intent associated with content 108.

In some embodiments, the negative sentiment determined by the system based on reactions to content may be related to the content being outdated or obsolete or otherwise false. For example, if content is determined to include the text “Congrats to the reigning champion Los Angeles Rams!” and be associated with a timestamp of 2024, and user comments on the content suggest that this comment is obsolete (e.g., pointing out that the Los Angeles Rams did not win the Super Bowl this year or even last year, but won in 2022), the system may perform a suitable correction. For example, the system may correct to the text to “Congrats to the reigning champion Kansas City Chiefs!” or “2022 Super Bowl Champion Los Angeles Rams!”).

In some embodiments, the system may use regenerated version 136 of content 108 to completely replace (or partially replace) content 108 on platform 104 and/or other platforms on which content 108 is being provided, for all users of those platforms, or for unique users of those platforms. For example, if a user's profile indicates that they have a preference for certain content, and the original content has attributes matching that preference, the original content 108 may be maintained for that user, even if regenerated version 136 is used instead of content 108 for other users. In some embodiments the system may regenerate different versions to serve to different users based on their input comments and/or reaction to content 106. For example, the system may regenerate a shorter version of the text with the same offensive content for the users that just complained about the text being too long (but did not otherwise have a problem with original content), while adjusting the text for a less controversial meaning for users whose reactions indicated a complaint about the original content 106. that complained about it

In some embodiments, the system may post regenerated version 136 of content 108 as a comment on content 108, or as a new social media post, or as a response to a negative comment on content 108. For example, the system may add regenerated version 136 as a comment to the original post 107, e.g., based on whether settings of the platform allow replacement, along with an indication that 136 is a new version of content 108, to supplement original content 108 with regenerate version 136 of content 108.

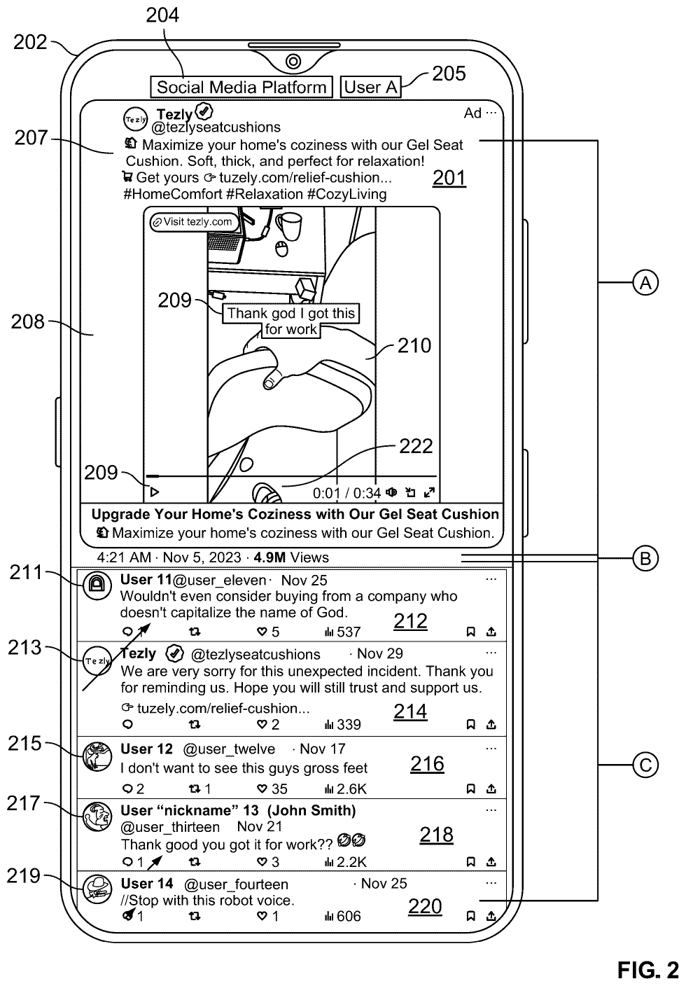

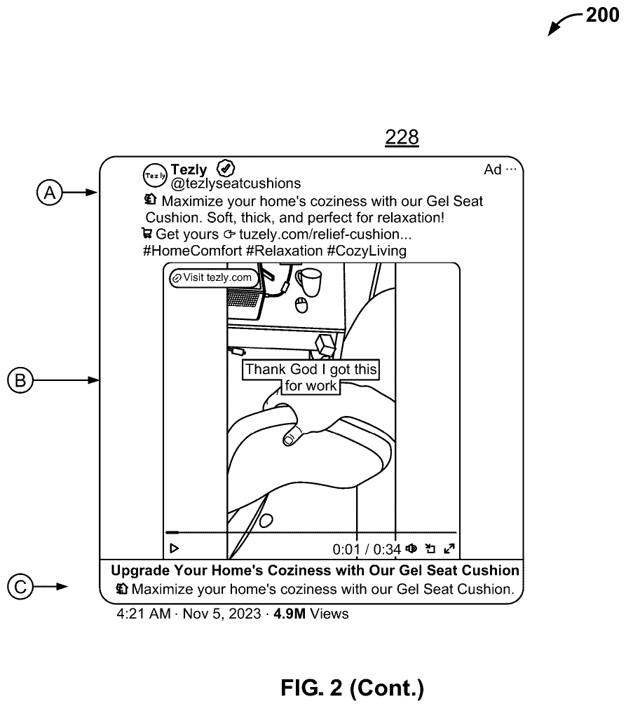

FIG. 2 shows an illustrative system 200 for regenerating content based on determined reactions to the content, in accordance with some embodiments of this disclosure. Content 208 may be posted via post 207 on social media platform 204 via user interface 201. Content 208 may include text portion 209 (e.g., “Maximize your home's coziness . . . ,” “Thank god I got this for work . . . ”) and media portion 210 (e.g., a frame of a video in which a person in holding a seat cushion with hir hand and foot visible in the frame).

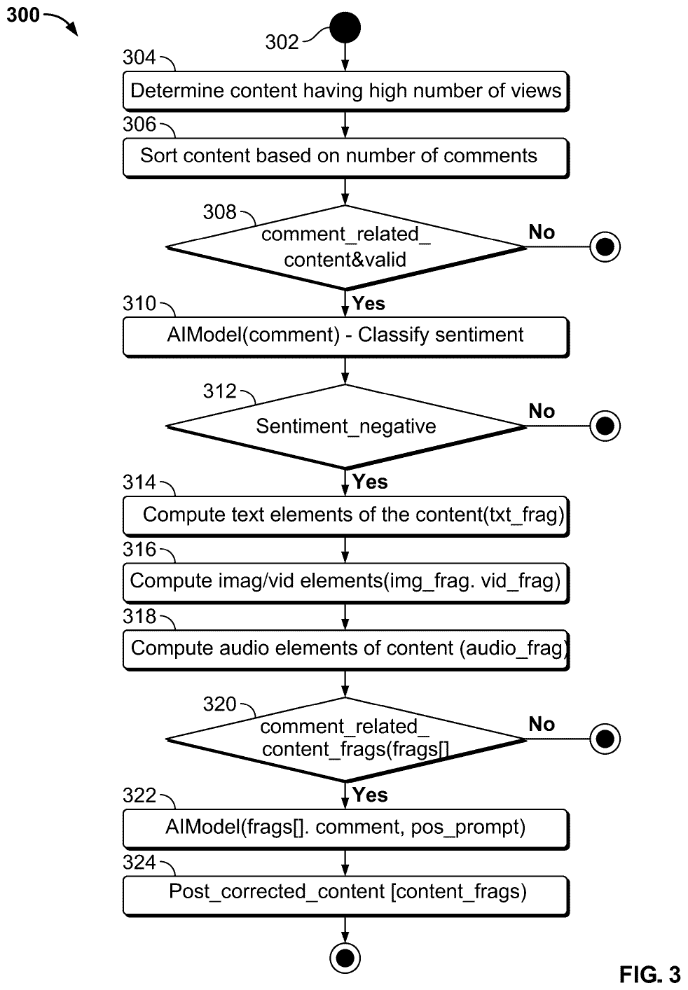

FIG. 3 shows an illustrative flowchart for regenerating content based on determined reactions to the content, in accordance with some embodiments of this disclosure. In various embodiments, the individual steps of process 300 may be implemented by one or more components of the devices, methods, and systems of FIGS. 1, 2, and 4-12 and may be performed in combination with any of the other processes and aspects described herein. Although the present disclosure may describe certain steps of process 300 (and of other processes described herein) as being implemented by certain components of the devices, methods and systems of FIGS. 1, 2, and 4-12, this is for purposes of illustration only, and it should be understood that other components of the devices, methods, and systems of FIGS. 1, 2, and 4-12 may implement those steps instead.

At 304, the system may determine that content 208 (e.g., an advertisement) has a high number of views and/or reactions (a number of views, reactions, or comments exceeding a threshold, d). For example, the system may make this determination based on inputs received from multiple devices accessing platform 204 and/or content engagement data stored at a server or database associated with the platform. At 306, the system may sort content having received a high number of reactions (e.g., exceeding a threshold). For example, the system may determine that content 208 has been reacted to more on platform 204 than other similar content or all other content, or is trending in terms of receiving a high number of comments.

At 308, the system may determine whether one or more of reactions 212, 214, 216, 218, and 220 (received from users 211, 213, 215, 217, and 219, respectively) are sufficiently related to content 208 and have been received from verified users. For example, the system may use similar techniques to those discussed in relation to 128 (e.g., one or more machine learning models) to determine that 212, 216, and 218 are sufficiently related to content 108. Reaction 214 may be determined to either not be related to content 208, or may be determined at 310 to be a positive sentiment related to content 208 (e.g., a heart symbol), and content 220 may be determined to be received from an unverified user and discarded from the analysis. A negative determination at 308 may cause processing to be concluded with respect to content 208 until more reactions are received in relation to content 208, while a positive determination may cause processing to proceed to 310.

For example, the system may determine that reaction 212 comprises text of “Maximize your home's coziness . . . ” and “Thank god I got this for work . . . ” and may obtain a natural language description of the frame of content 208 (e.g., including “feet,” “hand,” “blue cushion,” “coffee mug,” “laptop,” and/or any other suitable descriptions). The system may determine that one or more portions of such text description of content 208 match one or more portions of the reactions to content 208 (e.g., the word “feet” in reaction 215, and the word “God” in reaction 212. In some embodiments, the determination that a reaction to related to sufficiently related to content 208 may be based on generating a semantic understanding of content 208 and a semantic and/or sentiment understanding for each reaction. For example, based on a natural language description of content 208, a vector may be generated in a vector space, and compared to a vector representative of a natural language description of a particular reaction, to determine whether the similarity exceeds a threshold. In some embodiments, the system may determine which portions of a reaction match portions of content 208, which may be multi-modal. In some embodiments, the system may remove comments that are irrelevant to the content from further steps of process 300. For example, a comment may be removed from further analysis if it is not intended as a response to the subject in the advertisement posted on the social media content platform.

At 312, the system may utilize the techniques described in relation to 130 of FIG. 1 to, e.g., using an AI model to classify a sentiment of each reaction as positive, negative or neutral. For example, reactions 212, 216, and 218 (and/or 220, if found to be from a verified user) may be determined to be negative in sentiment, and reaction 214 may be determined to be positive in sentiment. In some embodiments, comment 218 may be determined to be neutral, e.g., an observation about what might happen in relation to topics related to content 208, rather than a criticism of topics related to content 208. For example, the system may have trained a model (or received a model) trained to associated words or phrases such as “gross” in reaction 216 or “Wouldn't even consider buying” in reaction 212 with a negative connotation. In some embodiments, the system may use NLP models, visual models, audio models, or a combination thereof to conduct a sentiment analysis of the comments.

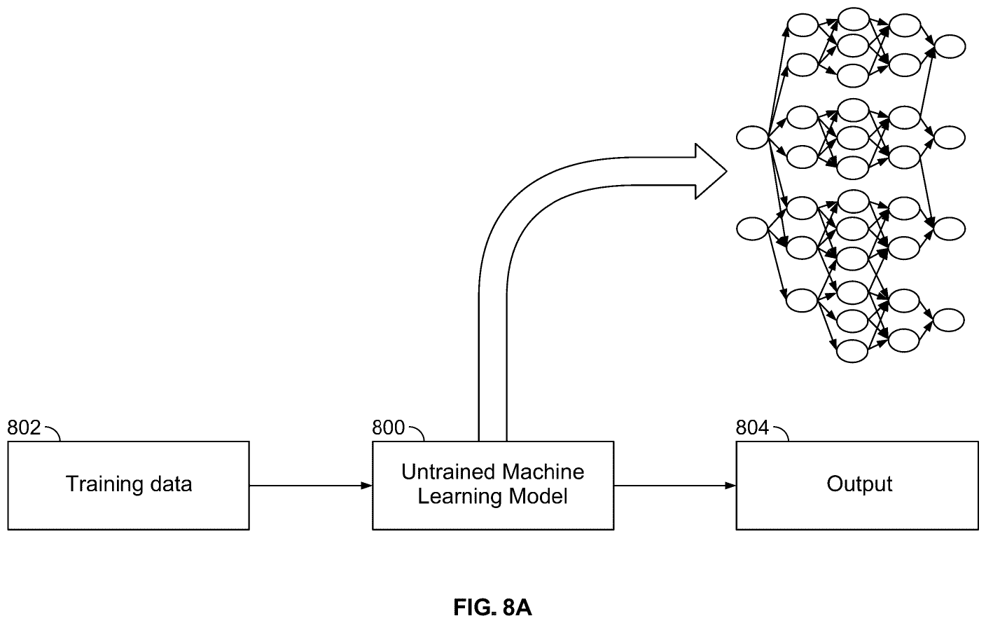

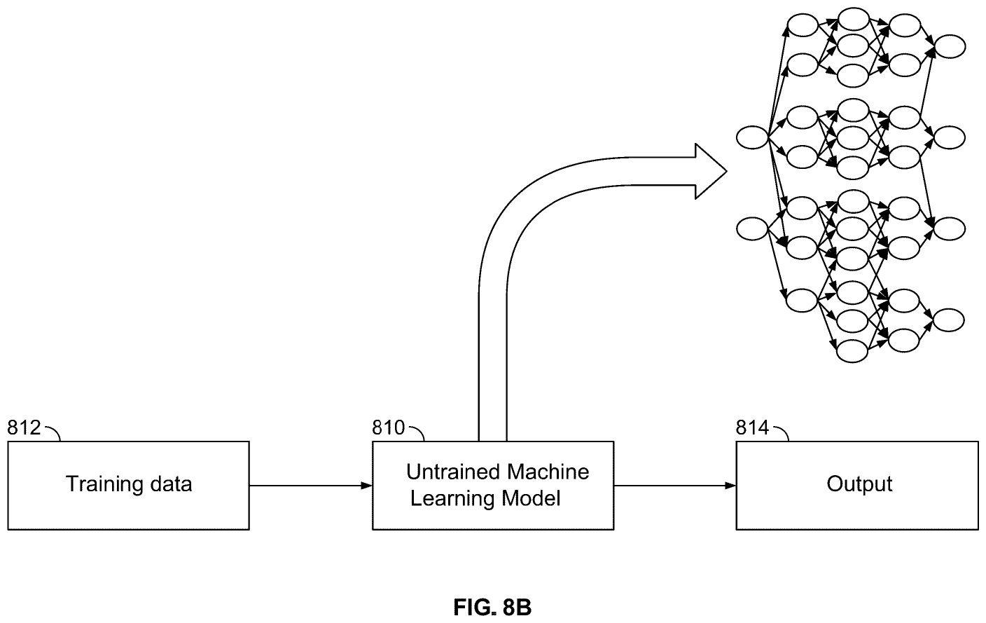

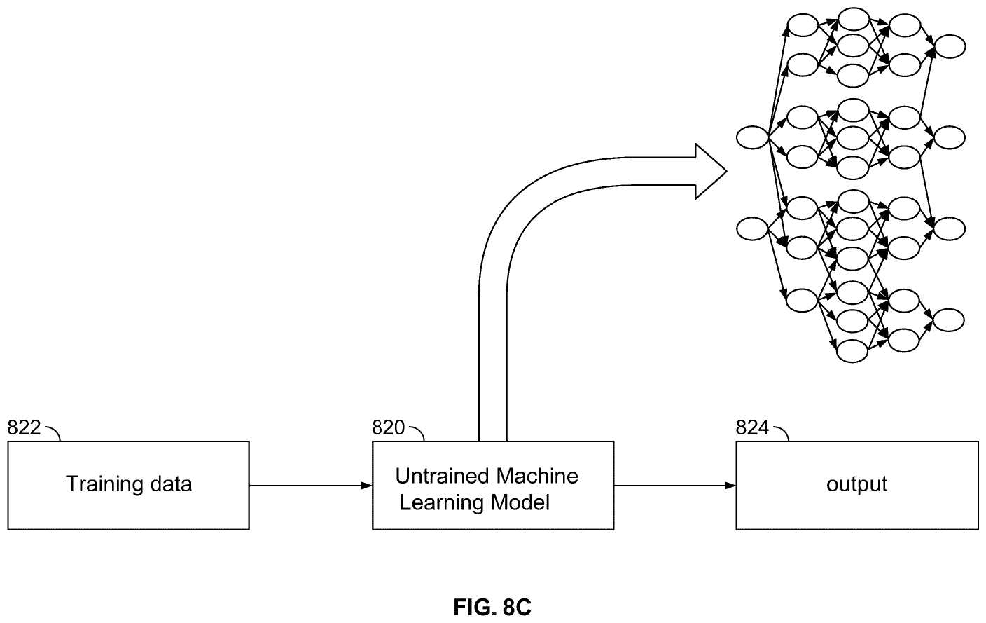

In some embodiments, the system may determine whether the sentiments of the remaining comments were deemed to be negative, or otherwise contradictory, to the content posted on the content platform. The system may determine a portion of the remaining comments that have negative/contradictory sentiments and parse the words that appear in those comments to check if they also appear in the posted content. In some embodiments, the system checks if the words that appear in the portion of comments are also in the aggregate bag of words that were constructed at step 808 of FIG. 8. The system may determine that some of the words from the portion of comments are also in the aggregate bag of words and indicate the matching words with a mark or other indication. In some embodiments, the system will conduct a similar process for audio, image, and video comments. The system may determine whether the audio, image, or video comments that have negative sentiments refer to any portions of the original content.

At 314, 316, and 318, the system may identify portions of content 208 that have an association with negative comments as a result of the multi-modal analysis. For example, a comment may indicate negative sentiments about an object in an image in the content. The system may determine that the portion of the image containing the object is related to the negative comment. In some embodiments, the system may create a mapping table of content portions that have an association with negative comments. In some embodiments, the system may create separate mapping tables for each of text, image, video, or audio portions of the content that have associations with negative comments. In some embodiments, a comment/reaction may refer to multiple audio or video frames.

For example, at 320, the system may determine that “god” of text portion 209 caused a reaction with a negative sentiment, and that the feet in the frame caused a negative reaction in comment 216 (which received a large number of likes in comparison to other comments). In some embodiments, each frame of the video in content 208 may be analyzed and compared to the reactions on platform 204.

At 324, the system may input, to a trained AI model, one or more of an indication of portion of the reactions determined to have caused the negative reaction (e.g., “god” and “feet′), an indication of a replacement portion (e.g., capitalized “God” instead of god in original content 208), and an indication of content 208 (or any suitable portion thereof). In some embodiments, based on reaction 216, the system may input to the trained AI model an indication to omit the portion 222 of content 208 that corresponds to the feet of the person depicted in content 208. Based on such input, the system may obtain a regenerated version 228 of content 208. The regenerated version 228 of content 208 may comprise a capitalized form of “God,” in contrast to the lower case “god” in content 208, and may remove the depiction of the feet, based on the feedback from the reactions to content 208.

At 322, the system may generate a corrected post, e.g., by replacing content 208 and/or post 207 with the regenerated version 228, or by causing regenerated version 228 to be posted as a new post or as a reply to one of more of the reactions 212, 214, 216, 218, and/or 220. In some embodiments, personalized version of the content may be presented to different users, e.g., user 211 may be presented with the capitalized “God” but with feet left in, and user 215 may be presented with the feet omitted but the lower case form of “god.” In some embodiments, the brand owner may be informed of the regenerated version 228 and may approve the posting of such regenerated version 228 of content 208 that addressed the user comments, e.g., the system may request permission prior to causing such regenerated version to be posted. In some embodiments, the system may collect advertisement measurement data for original and re-generated advertisement variants, and/or if multiple versions of the same ad exist after regeneration, keep track of comments per version and inform commenters of new versions.

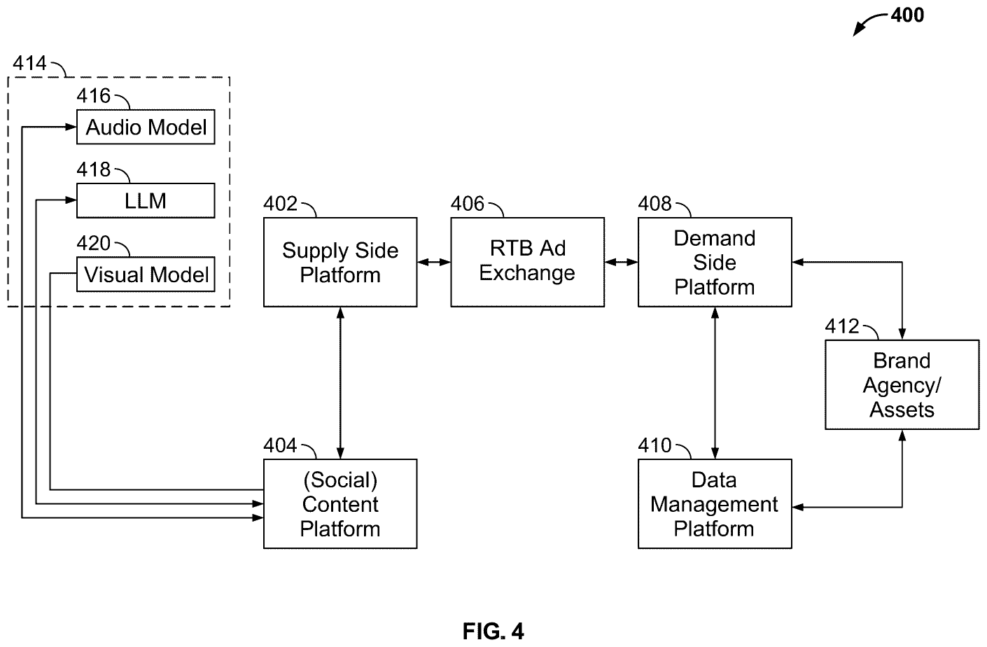

FIG. 4 shows a block diagram of a system 400, in accordance with some embodiments of this disclosure. In some embodiments, system 400 may correspond to system 100 and system 200 of FIGS. 1-2. While FIG. 4 describes modifying advertisements, in some embodiments, any suitable content other than advertisements may be analyzed and modified. Content platform 404 may correspond to platforms 104 and 204 of FIGS. 1-2. Content platform 404 may provide for display content provided by content provider 412 (e.g., a brand or agency or other publisher). In some embodiments, content provider 412 may be included as part of system 400 or may be in communication with system 400 by way of demand side platform (DSP) 408 and data management platform (DMP) 410. In some embodiments, DMP 410 may be a type of user platform or software that allows for a publisher to request for, bid for, or purchase space (e.g., ability to post promotional content, display space, banner space, etc.) on content platform 404. In some embodiments, DSP 408 may have a DMP 410 counterpart, and such DMP 410 may store and organize and organizes metadata related to content on the content platform 404, such as user behavior and demographic information, and other metrics for publishers to measure their content with. In some embodiments, DMP 410 may comprise mechanisms for collecting and measuring data from outside sources such as website traffic, mobile applications, customer relationship management (CRM) systems, third-party data providers, and any other outside source or any combination thereof. In some embodiments, DMP 410 may extract data from these outside sources, process and/or convert the data to a preferred format by the data management platform, and store the data into a database within DMP 410.

In some embodiments, DSP 408 and supply side platform (SSP) 404 are connected to each other via bidding platform 402, such as a real-time-bidding (RTB) ad exchange. In some embodiments, content platform 404 lists available content inventory (e.g., space on the content platform) on the SSP 402 for content provider 412 to bid on through bidding platform 406.

In some embodiments, the analysis of content (e.g., content 108 of FIG. 1), analysis of reactions to the content analysis, and regenerating of a new version of content, described in FIGS. 1-3, may occur entirely on, or at least in part on, content platform 404. In some embodiments, such analysis may be done on content platform 404, and the results from the analysis may be sent by content platform 404 to SSP 402, and then transferred to the DSP 408 through bidding platform 406, and further transmitted to content provider 412. DSP 408 may store the results of the analysis on the DMP 410, and the result may be available for access by content provider 412 on DMP 410. In some embodiments, SSP 402, DSP 408, and/or other components (e.g., a full suite of an advertising ecosystem) of FIG. 4 may be controlled by or otherwise associated with platform 404.

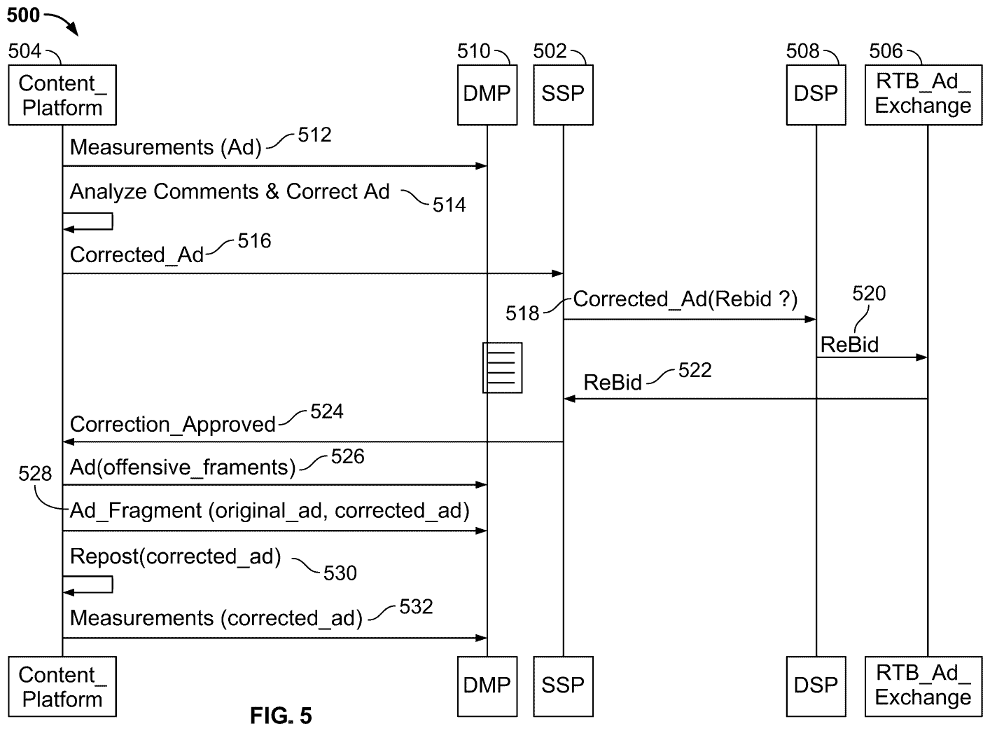

In some embodiments, when content provider 312 is informed of the results of the content/reaction analysis 414, content provider 412 may send an indication back to system 400 to allow or disallow the regenerative processes to take. In some embodiments, when platform 404 completes its negative connotation analysis of the user comments, it may determine to re-execute RTB ad exchange 406 by pushing a notification from SSP 402 to DSP 408, indicating the corrective re-generated content may change the previous RTB bidding process, as shown in relation to FIG. 5.

In some embodiments, content platform 404 may, via SSP 402, inform DMP 410 of any offending portions (or otherwise candidate portions to be replaced) such as words/objects/video-audio frames that were detected via content/reaction analysis at 414 (e.g., including audio model 416, LLM 418, and visual model 420). DMP 410 may record this data while collecting and making attributions in terms of advertisement measurement and/or effectiveness computations.

In some embodiments, the analysis of content (e.g., content 108 of FIG. 1), analysis of reactions to the content, and regenerating of a new version of content, described in FIGS. 1-3, may occur entirely on, or at least in part on, DSP 408, DMP 410, content provider 412, and/or any other suitable portion of system 400, or using any other suitable component, or any suitable combination thereof. For example, the advertisers, or DSP 408, on behalf of the advertisers, may perform metadata analysis (e.g., ahead of time or in real time) or other analysis in relation to text, images, objects, audio, or video of content and store the results of such analysis on DMP 410. This process may accelerate the regenerative processes on the content platform as the user comments are being received. In some embodiments, content provider 412 may purposefully add a provocative or negative content fragment (e.g., a provocative word, image, object, sound, etc.) to the content. Content provider 412 may surgically measure the impact of the provocative or negative content fragment in terms of how it is received by analyzing the reaction data to the content. For instance, in FIG. 1, the publishers may have liberally and deliberately used the word “property” to attract viewers on the content platform. However, if the publisher is informed by content platform 404 through SSP 402 that the word is not being received well by the platform's users based on the reaction analysis process, it may auto improve the regenerative process that is being suggested by the content platform. The system may send a flag from the DSP 408 about the potential provocative or obsolete word, image, object, sound, etc. (e.g., the word “property” indicated in FIG. 1) instantaneously. The provocative or obsolete word, image, object, sound, etc. (e.g., the word “property”) may be fed as input into GAN multi-modal models 414 as further inputs, for instance as text embedding, both for detection and regeneration.

In some embodiments, content provider 412 may run a re-generative step itself and pass the modified advertisement content back to the content platform via DSP 408, ad exchange 406 and/or SSP 402, and/or and all other content platforms on which the advertisement content is being hosted. In some embodiments, the DSP/SSP workflow may be short-circuited, and new advertisement content may be pushed to the content platform(s) as soon as possible to contain the negative impact and push the corrective re-generated content as quickly as possible.

In some embodiments, system 400 may provide the benefit for enabling advertisements to evolve themselves based on the feedback from the audience that they are trying to get engagement from. This way, rather than leaving all the engagement value on the table, they can go a step further and adapt their advertisement based on the response from their audience. This may enable removing the burden of the advertisement creator involvement in monitoring feedback to their advertisement and reduce time lag between feedback and advertisement evolution. Thus, after the self-correcting advertisement refresh, the engagement with and reception of the advertisement by the audience can be improved.

FIG. 5 is a flowchart of a detailed illustrative process 500 for analyzing and correcting content from content platform 504, in accordance with some embodiments of this disclosure. In some embodiments, the system may comprise a content platform 502 (e.g., corresponding to platform 404), DMP 510 (e.g., corresponding to DMP 410), SSP 502 (e.g., corresponding to SSP 402), a demand side platform (DSP) 508 (e.g., corresponding to DSP 408), and a bidding platform (e.g., an ad exchange) 506 (e.g., corresponding to ad exchange 406).

At 512, content platform 504 (e.g., social media platform 104 of FIG. 1) transmits measurements associated with content (e.g., an advertisement) to DMP 510. For example, the social media platform may store information such as likes, comments, engagements, other post metrics, or a combination thereof, regarding a social media post on the DMP's databases. At 514, content platform 504 performs an analysis of reactions (e.g., user comments) associated with the content (e.g., sentiment analysis machine) and/or performs a correction of such content. For example, the content platform may use multi-modal machine learning models to determine a sentiment and/or semantic analysis of comments of a content item. The content platform may use secondary generative multi-modal machine learning models to regenerate portions of or the complete content. At 516, content platform 502 may transmit the regenerated/corrected content to SSP 502. At 518, SSP 502 may send the regenerated/corrected content and a request to DSP 508 for permission to publish the regenerated/corrected content. At 520, the publisher through DSP 508 sends a rebidding request for the regenerated/corrected content through the bidding platform 506 (e.g., ad exchange) to SSP 502. At 522, SSP 502 receives the rebidding request for the regenerated/corrected content. At 524, SSP 502 sends the regenerated/corrected content to content platform 502. At 526, content platform 502 identifies portions of the content that may need to be regenerated that were identified through content analysis 514, and stores the portions of the content on DMP 510. At 528, content platform 502 stores both the original portions of the content that were regenerated and the regenerated/corrected portions of the content onto DMP 510. At 530, content platform 502 publishes the regenerated/corrected content in place of the original content. At 532, content platform 502 transmits measurements (e.g., number of likes, comments, engagements, etc.) of the regenerated/corrected content for storage on DMP 510.

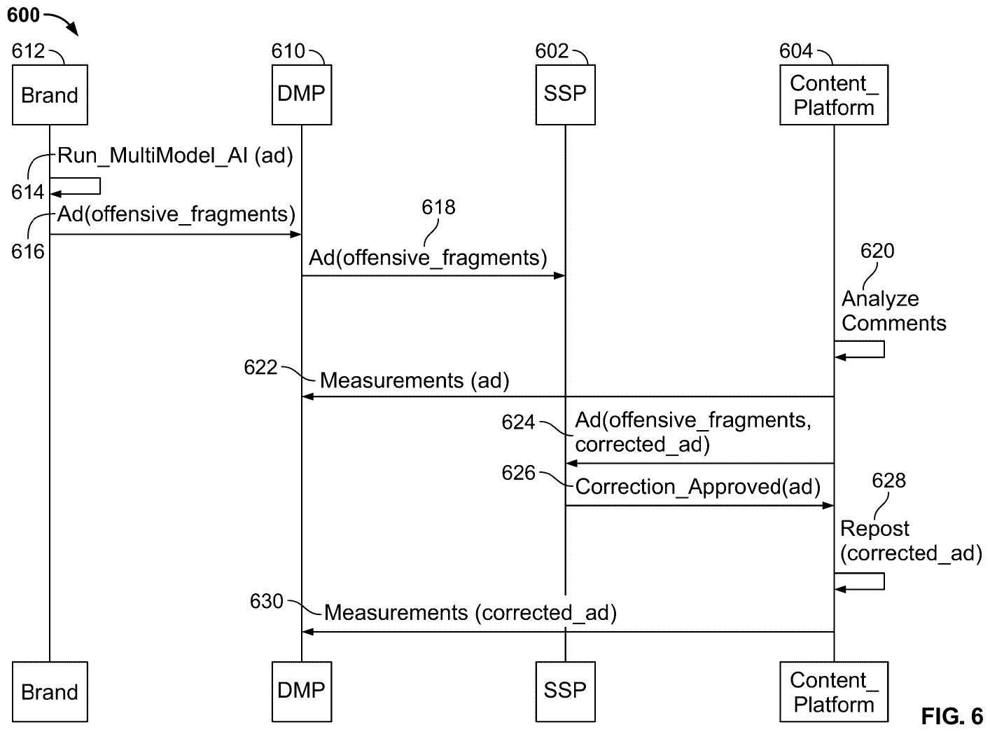

FIG. 6 is a flowchart of a detailed illustrative process 600 for analyzing and correcting content from a content platform 604, in accordance with some embodiments of this disclosure. In some embodiments, the system may comprise a content platform 604 (e.g., corresponding to platform 404), DMP 610 (e.g., corresponding to platform 410), SSP 602 (e.g., corresponding to SSP 402), and brand or content provider 612 (e.g., corresponding to content provider 412) . . . .

At 614, publisher 612 performs a content analysis of the content intended to be published on content platform 604. In some embodiments, the content analysis is a multi-modal machine learning model that can understand the semantics and sentiment of the content. At 616, publisher 612 stores portions of the content that were deliberately created to invoke negative sentiments to DMP 610. At 618, DMP 610 sends the portions of the content deliberately created to invoke negative sentiments to SSP 602. In some embodiments, the portions of the content deliberately created to invoke negative sentiments are published with the content on content platform 604. At 620, content platform 604 analyzes reactions such as likes, comments, engagements, other post metrics, or a combination thereof, of the content. At 622, content platform 604 stores the metrics from analysis 620 on DMP 610. At 624, content platform 604 assesses the sentiment of the reactions to the published content, regenerates the portions of the content that received negative sentiments, corrects the content with the regenerated portions, and sends the corrected content to SSP 602 with the portions of the content that received negative sentiments. At 626, publisher 612 sends an approval through SSP 602 to publish the corrected content in place of the original content. At 630, content platform 604 analyzes reactions such as likes, comments, engagements, other post metrics, or a combination thereof, of the content, and stores the metrics from the analysis on DMP 610.

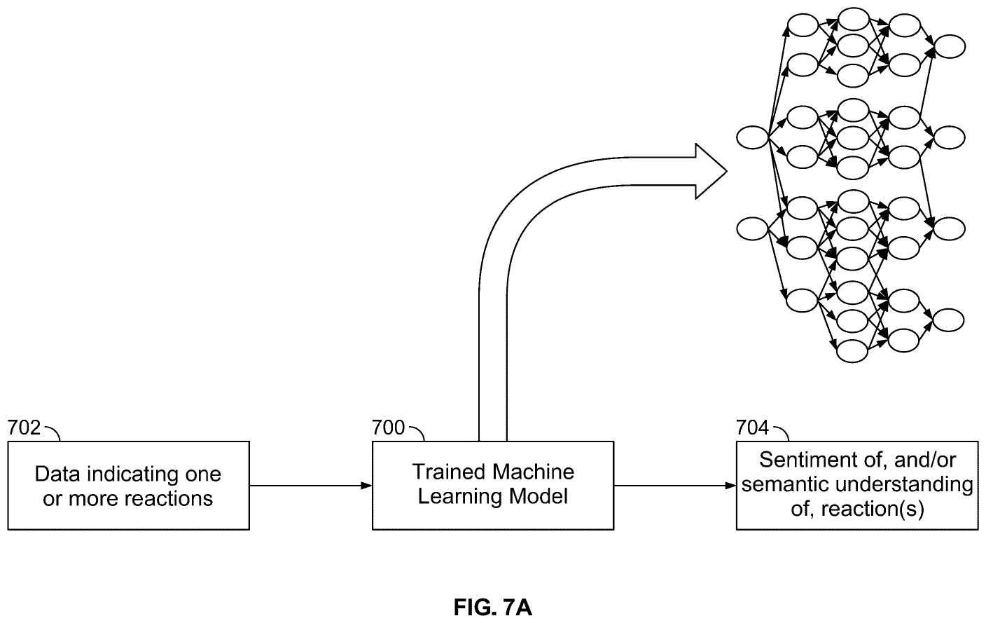

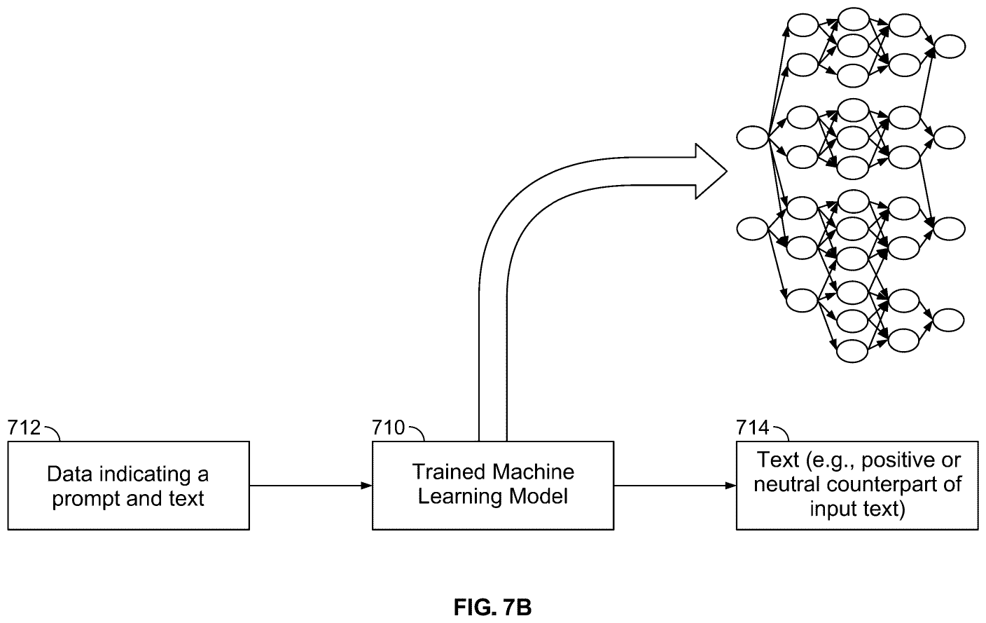

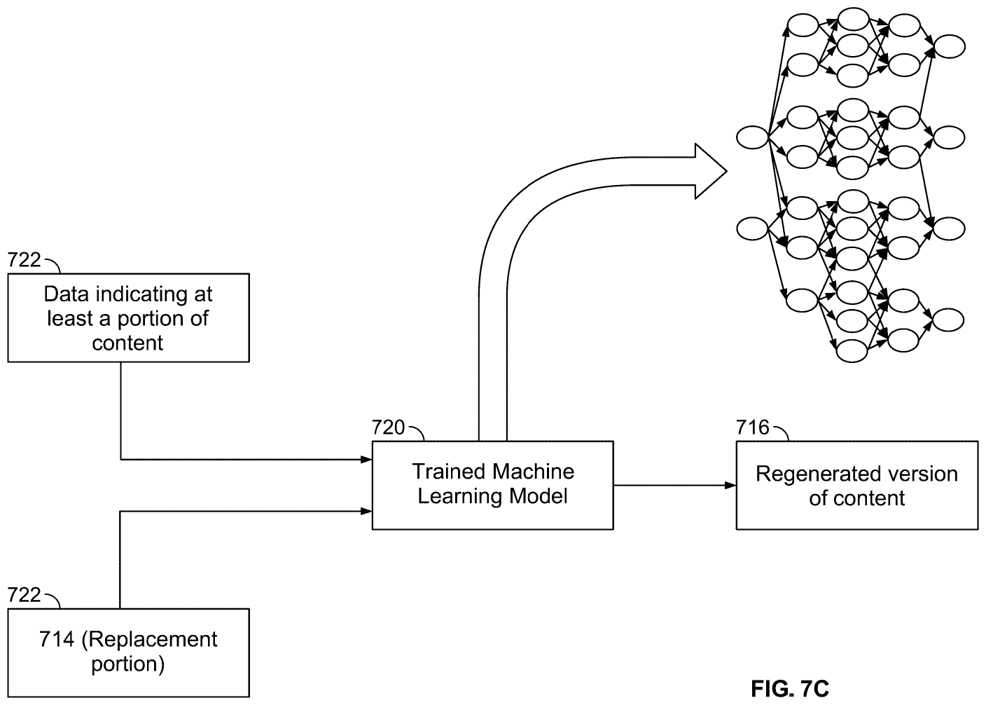

FIGS. 7A-7C shows block diagrams of illustrative trained machine learning models 700, 710, and 720, in accordance with some embodiments of this disclosure. In some embodiments, machine learning models 700, 710, and/or 720 may be, for example: an LLM, neural network, a recurrent neural network, a convolutional neural network, a generative adversarial neural network, an image encoder, a text encoder, a transformer, a classifier, or any other suitable type of machine learning or AI model, or any combination thereof.

In some embodiments, trained machine learning model 700 may be used to, in the example of FIG. 1, obtain a sentiment and/or semantic understanding of post 107 and/or content 108, and/or to obtain a sentiment and/or semantic understanding for reactions 112, 114, 116, 118, 120, and 122. In some embodiments, machine learning model 700 may be used to, in the example of FIG. 2, obtain a sentiment and/or semantic understanding of post 207 and/or content 208, and/or to obtain a sentiment and/or semantic understanding for reactions 212, 214, 216, 218, and 220.

In some embodiments, trained machine learning model 700 may be configured to receive input 702 of data indicating one or more reactions to content. For example, input 702 may be indicative of text, audio (e.g., converted to text), images or video (e.g., converted to a natural language representation describing the image and/or video) of original content or reactions thereto. For example, to obtain such natural language representation, the system may employ an image-to-text machine learning model. In some embodiments, the data indicating one or more reactions to content may comprise one or more portions of the content or reactions or portions thereof, metadata of the content or reactions or portions thereof, a description of the content or reactions or portions thereof, a numerical representation of the content or reactions or portions thereof, and/or other representation of the content or reactions or portion thereof, or any other suitable data, or any combination thereof.

Based on input 702, trained machine learning model 700 may be configured to output a sentiment of, and/or semantic understanding of, content (e.g., content 108 of FIG. 1) and/or reactions (e.g., 112, 114, 116, 118, and 120 of FIG. 1). In some embodiments, machine learning model 700 may be configured to output an indication of whether a particular input reaction has a positive sentiment, negative sentiment, or neutral sentiment. In some embodiments, machine learning model 700 may be configured to output respective indications of whether each of multiple input reactions has a positive sentiment, negative sentiment, or neutral sentiment. In some embodiments, machine learning model 700 may be configured to output a first percentage of input reactions having a positive sentiment, a second percentage of input reactions having a negative sentiment, and a third percentage of input reactions having a neutral sentiment. In some embodiments, machine learning model 700 may receive as input, or otherwise be configured to be implemented, based at least in part on one or more parameters (e.g., a choice of sampler, a number of iterations, an attention factor, or any other suitable parameter(s), or any combination thereof).

In some embodiments, trained machine learning model 710 of FIG. 7B may be used to, in the example of FIG. 1, obtain a replacement portion (e.g., “proud daughter”) as output 714 to be used in a regenerated version of content (e.g., 108) instead of a portion of the content (e.g., “property”) determined based on the reactions to the content as contributing to a negative sentiment towards the content (e.g., content 108). For example, data indicating the word “property” and/or other surrounding portions for context (e.g., “daughter but not yours, I am the . . . of a freaking awesome dad”) may be input to trained machine learning model 710 along with a prompt to generate something neutral or positive instead of the identified portion. In some embodiments, input 712 may be text that corresponds to text of content 108, audio of content 108, or images and/or video of content 108. In some embodiments, a desired output length may be specified as input to model 710. In some embodiments, input 712 may comprise data indicative of a portion of an image (e.g., the toes of a foot in 222) having a negative sentiment based on reactions thereto, and model 710 may output at 714 a positive or neutral counterpart of such image (e.g., an image of a shoe with similar dimensions as the foot 222, to hide the bare toes of the user).

In some embodiments, trained machine learning model 720 of FIG. 7C may be used to, in the example of FIG. 1, obtain as output 716 a regenerated version of content (e.g., regenerated version 136 of content 108 of FIG. 1). In some embodiments, model 720 may be a generative AI model. Trained machine learning model 720 may receive, as input, data indicating at least a portion of the content (e.g., portions of content 108 of FIG. 1 having been linked to the negative sentiment, and/or any other suitable portions of content 108) 722, an indication of what portion in the content is to be changed and associated with the negative sentiment (e.g., the word “property” in the example of FIG. 1), and input 722 (e.g., corresponding to output 714 of FIG. 7B comprising data indicating the positive or neutral counterpart). In some embodiments, input to model 720 may include an instruction to omit certain portions originally present in the content or to use a positive or neutral counterpart instead of the certain portions. Trained machine learning model 720 may be configured to regenerate, rearrange, and/or stitch together one or more new portions of content to obtain a regenerated version of the original content. In some embodiments, if the original content is text content, inputs to machine learning model 720 may comprise a prompt including the original content, analysis results of the reactions, and a command asking the model (e.g., an LLM) to revise the content based on the reactions. In some embodiments, the LLM may generate text in desired formats using text prompts as input; and/or the LLM may be trained to visually inspect pixels for use in its neural net to generate relevant text and/or images, among other modalities; and/or the LLM may be interconnected with other forms of AI to not just digest but also output pixels.

The inputs to trained machine learning models 700, 710, and 720 may be in any suitable form, e.g., a numerical representation such as a vector with n dimensions. In some embodiments, words associated with such inputs may be tokenized. In some embodiments, the functionalities performed by machine learning models 700, 710, and 720 may be performed by a single machine learning model.

In some embodiments, as shown in FIGS. 8A-8C, trained machine learning model 700 may be generated by using training data 802 to train untrained machine learning model 800 of FIG. 8A, trained machine learning model 710 may be generated by using training data 812 to train untrained machine learning model 810 of FIG. 8B, and trained machine learning model 720 may be generated by using training data 822 to train untrained machine learning model 820 of FIG. 8C. In some embodiments, untrained machine learning models 800, 810, and 820 may be trained by an iterative process of adjusting weights (and/or other parameters) for one or more layers of the machine learning model(s).

For example, to obtain model 700, the system input training data 802 (e.g., image data, text data, video data, and/or audio data, from one or more sources, annotated with sentiment indications) into untrained model 800, to obtain outputs 804. In some embodiments, model 800 may be trained on a plurality of posts from social media platform (and/or other platforms) and data describing the semantic meaning and/or sentiment of the plurality of posts. The plurality of posts and the data describing the subject matter of the plurality of posts may comprise text, audio, images, videos, and/or any other suitable data.

As another example, to obtain model 710, the system may input training data 812 (e.g., a textual corpus from one or more sources) into untrained model 810, to generate output 814. As another example, to obtain model 720, the system may input training data 822 (e.g., text and image pairs from one or more sources) into untrained model 810, to generate output 814. In some embodiments, the training process may include comparing such respective outputs 804, 814, 824 to ground truth values (e.g., annotated indications of the correct or desired outputs for given input(s)). In some embodiments, the system may then adjust weights or other parameters of machine learning models 800, 810, and 820 based on how closely the output corresponds to the ground truth value. In some embodiments, training process may be repeated until results stop improving or until a certain performance level is achieved (e.g., until 95% accuracy is achieved, or any other suitable accuracy level or other metrics are achieved).

The machine learning models 500, and their training data and/or input and output data may be stored at any suitable device(s) and/or server(s) of the system. The implementation and training of the machine learning model 500 (and 510) may be performed at any suitable device(s) and/or server(s) of the system. In some embodiments, FIGS. 7A-7C may be understood as an inference stage, and FIGS. 8A-8C may be understood as a training stage.

In some embodiments, model 800, 810, and 820 may be trained to learn features and patterns with respect to particular features of image or text inputs (e.g., certain types or categories of images or text) and corresponding representations thereof. Such learned patterns and inferences may be applied to received data once model 800, 810, and 820 is trained. In some embodiments, untrained models 800, 810, and 820 may be trained to obtain models 700, 710, and 720, respectively, and/or models 800, 810, and 820 may continue to be trained on the fly or may be adjusted on the fly for continuous improvement, based on input data and inferences or patterns drawn from the input data, and/or based on comparisons after a particular number of cycles. In some embodiments, models 700, 710, and 720 may be content-independent or content-dependent, e.g., may continuously improve with respect to certain types of content. In some embodiments, models 700, 710, and 720 may comprise any suitable number of parameters.

In some embodiments, models 800, 810, and 820 may be trained with any suitable amount of training data from any suitable number and/or types of sources. In some embodiments, machine learning models 800, 810, and 820 may be trained by way of unsupervised learning, e.g., to recognize and learn patterns based on unlabeled data. In some embodiments, machine learning models 800, 810, and 820 may be trained by supervised training with labeled training examples to help the model converge to an acceptable error range, e.g., to refine parameters, such as weights and/or bias values and/or other internal model logic, to minimize a loss function. In some embodiments, each layer may comprise one or more nodes that may be associated with learned parameters (e.g., weights and/or biases), and/or connections between nodes may represent parameters (e.g., weights and/or biases) learned during training (e.g., using backpropagation techniques, and/or any other suitable techniques). In some embodiments, the nature of the connections may enable or inhibit certain nodes of the network. In some embodiments, the system may be configured to receive (e.g., prior to training) user specification of (or automatic selection of) hyperparameters (e.g., a number of layers and/or nodes or neurons in each model). The image system may automatically set or receive manual selection of a learning rate, e.g., indicating how quickly parameters should be adjusted. In some embodiments, the training image data may be suitably formatted and/or labeled by human annotators or otherwise labeled via a computer-implemented process. As an example, such labels may be categorized metadata attributes stored in conjunction with or appended to the training image data. Any suitable network training patch size and batch size may be employed for training untrained models 800, 810, and 820. In some embodiments, models 800, 810, and 820 may be trained at least in part using a feedback loop, e.g., to help learn user preferences over time.

In some embodiments, the system may perform any suitable pre-processing steps with respect to training data, and/or data to be input to the trained machine learning model. For example, pre-processing may include causing an image that is to be input to be of a particular size or resolution. In some embodiments, pre-processing may include causing text that is to be input to be of a particular size or format. In some embodiments, pre-processing may include, for example, extracting suitable features from the training images and converting the features into a suitable numerical representation (e.g., one or more vector(s) and/or one or more matrices); normalization; resizing; minimization; brightening portions thereof; darkening portions thereof; color shifting the image among color schemes from color to grayscale; other mapping; cropping the image; scaling the image; adjusting an aspect ratio of the image; adjusting contrast of an image; and/or performing any other suitable operating on or manipulating of the image data; or any combination thereof. In some embodiments, the image capture system may pre-process image or text data to be input to the trained machine learning model, to cause a format of the input image or text data to match the formatting of the training data, or any other suitable processing may be performed, or any combination thereof.

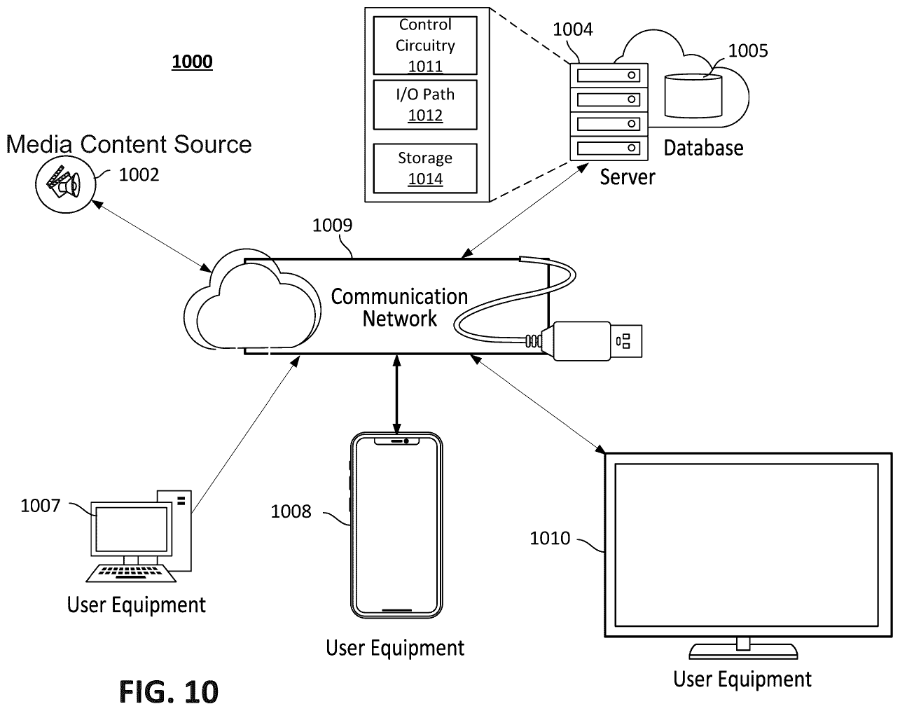

In some embodiments, machine learning models 800, 810, and 820 may be trained “offline” using labeled data, such as, for example, at a server (e.g., server 1004 of FIG. 10) remote from a computing device at which input is received, or at a third party. In some embodiments, models 700, 710, and 720 may be implemented at such remote server, and/or abstracted by the system (for example, as a set of weights or biases applied to a neural network) and transmitted (e.g., over network 1009 of FIG. 10) to a user's computing devices, e.g., having the system installed or implemented thereon or provided thereto. For example, the local computing device may lack computational and/or storage resources to train the model from scratch. In some embodiments, each device may iteratively improve the machine learning models 700, 710, and 720 locally and send the abstracted model and/or updates back to the server. In some embodiments, the user's computing devices may be configured to locally implement machine learning model 700 (and 800).

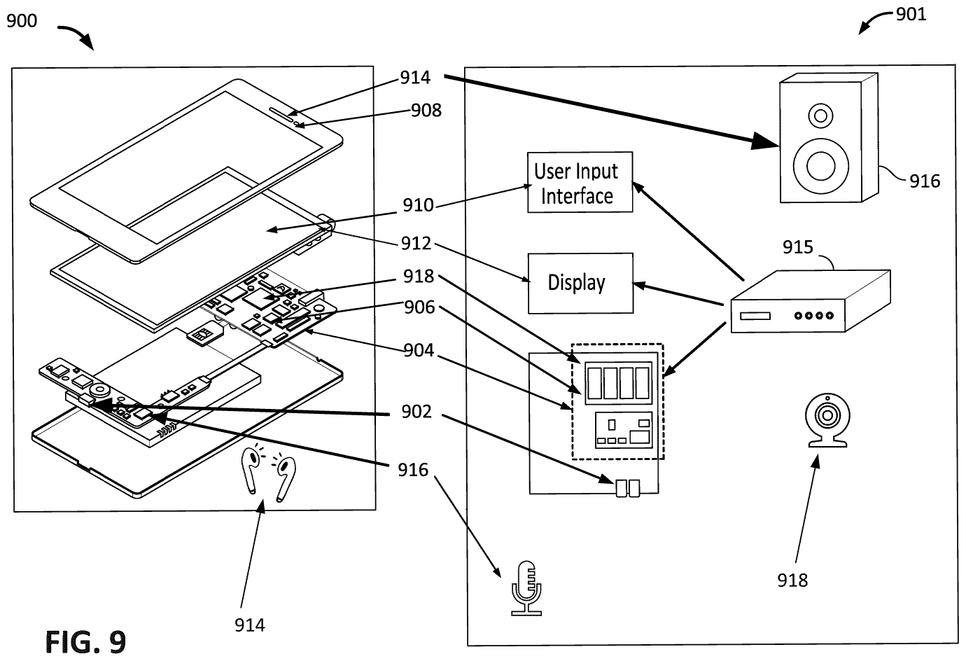

FIGS. 9-10 show illustrative devices, systems, servers, and related hardware for regenerating content based on determined reactions to the content, in accordance with some embodiments of this disclosure. FIG. 9 shows generalized embodiments of illustrative computing devices 900 and 901 (e.g., device 102 of FIG. 1), which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 901 may be a user television equipment system or device.

User television equipment device 901 may include set-top box 915. Set-top box 915 may be communicatively connected to microphone 916, Audio output equipment (e.g., speaker or headphones 914), and display 912. In some embodiments, microphone 916 may receive audio corresponding to a voice of a user providing input. In some embodiments, display 912 may be a television display or a computer display. In some embodiments, set-top box 915 may be communicatively connected to user input interface 910. In some embodiments, user input interface 910 may be a remote control device. Set-top box 915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 11. In some embodiments, computing device 900 may comprise any suitable number of sensors (e.g., gyroscope or accelerometer, etc.), and/or a GPS module (e.g., in communication with one or more servers and/or cell towers and/or satellites) to ascertain a location of computing device 900. In some embodiments, computing device 900 comprises a rechargeable battery that is configured to provide power to the components of the device.

Each one of computing device 900 and computing device 901 may receive content and data via input/output (I/O) path 902. I/O path 902 may provide content (e.g., broadcast programming, on-demand programming, Internet content, content available over a local area network (LAN) or wide area network (WAN), and/or other content) and data to control circuitry 904, which may comprise processing circuitry 906 and storage 908. Control circuitry 904 may be used to send and receive commands, requests, and other suitable data using I/O path 902, which may comprise I/O circuitry. I/O path 902 may connect control circuitry 904 (and specifically processing circuitry 906) to one or more communications paths (described below). I/O functions may be provided by one or more of these communications paths, but are shown as a single path in FIG. 9 to avoid overcomplicating the drawing. While set-top box 915 is shown in FIG. 9 for illustration, any suitable computing device having processing circuitry, control circuitry, and storage may be used in accordance with the present disclosure. For example, set-top box 915 may be replaced by, or complemented by, a personal computer (e.g., a notebook, a laptop, a desktop), a smartphone (e.g., computing device 900), an XR device; a tablet; a network-based server hosting a user-accessible client device; a non-user-owned device; any other suitable device; or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 904 executes instructions for the system or application stored in memory (e.g., storage 908). Specifically, control circuitry 904 may be instructed by the system or application to perform the functions discussed above and below. In some implementations, processing or actions performed by control circuitry 904 may be based on instructions received from the system or application.

In client/server-based embodiments, control circuitry 904 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 1008, and executed by control circuitry 904 of a computing device 900.

In some embodiments, the system or application may be a client/server application where only the client application resides on device 900 (e.g., device 102 of FIG. 1), and a server application resides on an external server (e.g., server 1004). For example, the system or application may be implemented partially as a client application on control circuitry 904 of device 900 and partially on server 1004 as a server application running on control circuitry 1111. Server 1004 may be a part of a local area network with one or more of computing devices 900, 901 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1004 and/or an edge computing device), referred to as “the cloud.” Device 900 may be a cloud client that relies on the cloud computing capabilities from server 1004 to determine whether content should be regenerated based on reactions to the content received on a platform. When executed by control circuitry of server 1004, the system or application may instruct control circuitry 1011 to perform processing tasks for the client device and facilitate the functionality of the system described herein. The client application may instruct control circuitry 904 to determine whether processing should be offloaded.

Control circuitry 904 may include communications circuitry suitable for communicating with a server, edge computing systems and devices, a table or database server, or other networks or servers The instructions for carrying out the above mentioned functionality may be stored on a server (which is described in more detail in connection with FIG. 10. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of computing devices, or communication of computing devices in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as the system or application data described above. Nonvolatile memory may also be used (e.g., to launch a boot-up routine and other instructions). Cloud-based storage, described in more detail in relation to FIG. 10, may be used to supplement storage 908 or instead of storage 908.

Control circuitry 904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 904 may also include scaler circuitry for upconverting and downconverting content into the preferred output format of computing device 900. Control circuitry 904 may also include digital-to-analog converter circuitry and analog-to-digital converter circuitry for converting between digital and analog signals. The tuning and encoding circuitry may be used by computing device 900, 901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from computing device 900, the tuning and encoding circuitry (including multiple tuners) may be associated with storage 908.

Control circuitry 904 may receive instruction from a user by way of user input interface 910. User input interface 910 may be any suitable user interface, such as a remote control, mouse, trackball, keypad, keyboard, touchscreen, touchpad, stylus input, joystick, voice recognition interface, or other user input interfaces. Display 912 may be provided as a stand-alone device or integrated with other elements of each one of computing device 900 and computing device 901. For example, display 912 may be a touchscreen or touch-sensitive display. In such circumstances, user input interface 910 may be integrated with or combined with display 912. In some embodiments, user input interface 910 includes a remote-control device having one or more microphones, buttons, keypads, any other components configured to receive user input or combinations thereof. For example, user input interface 910 may include a handheld remote-control device having an alphanumeric keypad and option buttons. In a further example, user input interface 910 may include a handheld remote-control device having a microphone and control circuitry configured to receive and identify voice commands and transmit information to set-top box 915.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 914 may be provided as integrated with other elements of each one of computing device 900 and computing device 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters, words, terms, or numbers that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 1018 may be an analog camera that converts to digital images via a video card.

The system or application may be implemented using any suitable architecture. For example, it may be a stand-alone application wholly-implemented on each one of computing device 900 and computing device 901. In such an approach, instructions of the application may be stored locally (e.g., in storage 908), and data for use by the application is downloaded on a periodic basis (e.g., from an out-of-band feed, from an Internet resource, or using another suitable approach). Control circuitry 904 may retrieve instructions of the application from storage 908 and process the instructions to provide the functionality, and generate any of the displays, discussed herein. Based on the processed instructions, control circuitry 904 may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, historical interactions by the user, and/or any other suitable data. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the system or application is a client/server-based application. Data for use by a thick or thin client implemented on each one of computing device 900 and computing device 901 may be retrieved on-demand by issuing requests to a server remote to each one of computing device 900 and computing device 901. For example, the remote server may store the instructions for the application in a storage device. The remote server may process the stored instructions using circuitry (e.g., control circuitry 904) and generate the displays discussed above and below. The client device may receive the displays generated by the remote server and may display the content of the displays locally on computing device 900. This way, the processing of the instructions is performed remotely by the server while the resulting displays (e.g., that may include text, a keyboard, or other visuals) are provided locally on computing device 900. Computing device 900 may receive inputs from the user via input interface 310 and transmit those inputs to the remote server for processing and generating the corresponding displays. For example, computing device 900 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to computing device 900 for presentation to the user.

In some embodiments, the system or application may be downloaded and interpreted or otherwise run by an interpreter or virtual machine (run by control circuitry 904). In some embodiments, system or application may be encoded in the ETV Binary Interchange Format (EBIF), received by control circuitry 904 as part of a suitable feed, and interpreted by a user agent running on control circuitry 904. For example, the system or application may be an EBIF application. In some embodiments, the system or application may be defined by a series of JAVA-based files that are received and run by a local virtual machine or other suitable middleware executed by control circuitry 904. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

FIG. 10 is a diagram of an illustrative system 1000 for regenerating content based on determined reactions to the content, in accordance with some embodiments of this disclosure. Computing devices 1007, 1008, 1010 (which may correspond to, e.g., computing device 900 or 901) may be coupled to communication network 1009. Communication network 1009 may be one or more networks including the Internet, a mobile phone network, mobile voice or data network (e.g., a 5G, 4G, or LTE network), cable network, public switched telephone network, or other types of communication network or combinations of communication networks. Paths (e.g., depicted as arrows connecting the respective devices to the communication network 1009) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 10 to avoid overcomplicating the drawing.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-10x, etc.), or other short-range communication via wired or wireless paths. The computing devices may also communicate with each other directly through an indirect path via communication network 1009.

System 1000 may comprise media content source 1002, one or more servers 1004, and/or one or more edge computing devices. In some embodiments, system or application may be executed at one or more of control circuitry 1010 of server 1004 (and/or control circuitry of computing devices 1007, 1008, 1010 and/or control circuitry of one or more edge computing devices). In some embodiments, the media content source and/or server 1004 may be configured to host or otherwise facilitate video communication sessions between computing devices 1007, 1008, 1010 and/or any other suitable computing devices, and/or host or otherwise be in communication (e.g., over network 1009) with one or more social network services.

In some embodiments, server 1004 may include control circuitry 1010 and storage 1014 (e.g., RAM, ROM, Hard Disk, Removable Disk, etc.). Storage 1014 may store one or more databases. Server 1004 may also include an input/output path 1012. I/O path 1012 may provide object data, context data, natural language descriptions, machine learning model inputs and/or outputs, device information, or other data, over a local area network (LAN) or wide area network (WAN), and/or other content and data to control circuitry 1010, which may include processing circuitry, and storage 1014. Control circuitry 1010 may be used to send and receive commands, requests, and other suitable data using I/O path 1012, which may comprise I/O circuitry. I/O path 1012 may connect control circuitry 1010 (and specifically control circuitry) to one or more communications paths.

Control circuitry 1010 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1010 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1010 executes instructions for an emulation system application stored in memory (e.g., the storage 1014). Memory may be an electronic storage device provided as storage 1014 that is part of control circuitry 1010.

FIG. 11 shows an illustrative flowchart for regenerating content based on determined reactions to the content, in accordance with some embodiments of this disclosure. In various embodiments, the individual steps of process 1100 may be implemented by one or more components of the devices, methods, and systems of FIGS. 1-12 and may be performed in combination with any of the other processes and aspects described herein. Although the present disclosure may describe certain steps of process 1100 (and of other processes described herein) as being implemented by certain components of the devices, methods and systems of FIGS. 1-12, this is for purposes of illustration only, and it should be understood that other components of the devices, methods, and systems of FIGS. 1-12 may implement those steps instead.

At 1102, the control circuitry (e.g., control circuitry 904 of computing device 900 or 901 of FIG. 9 and/or control circuitry 1011 of server 1004 of FIG. 10) may identify content being displayed (e.g., content 108) on one or more platforms (e.g., platform 104 of FIG. 1), e.g., a social media platform or any other suitable platform. At 1104, the control circuitry may identify reactions (e.g., reactions 112, 114, 116, 118, and 120 of FIG. 1) to the content (e.g., content 108 of FIG. 1). For example, the control circuitry may identify, as the reactions, comments posted in response to, or comments otherwise mentioning or referencing, post 107 comprising content 108, on the same platform as post 107 or on a different platform than the platform of post 107.

At 1106, the control circuitry may determine whether a number of reactions and/or views identified at 1104 exceeds one or more thresholds. For example, the control circuitry may identify any interaction where input is received in relation to the content (e.g., content 108 of FIG. 1). In some embodiments, a view without commenting on, liking, disliking, sharing the content, or otherwise providing further input in relation to the content may not be considered a reaction. If one or more of the reactions or views fails to exceed one or more thresholds, processing may return to 1102 to wait for more reactions on the content or to identify other content that may be a better candidate for being regenerated. Otherwise, processing may proceed to 1108. In some embodiments, a ratio of views to reactions may be considered, e.g., if content has 100,000 views but only two comments, processing may return to 1102 to wait for more reactions on the content or to identify other content that may be a better candidate for being regenerated.

At 1108, the control circuitry may determine, for each identified reaction (e.g., 112, 114, 116, 118, and 120 of FIG. 1), whether the reaction has been received from a verified user. For example, a profile of each user (e.g., 111, 113, 115, 117, 119 and 121 having posted reactions 112, 114, 116, 118, and 120, respectively, to content 108 of FIG. 1) may be analyzed to determine whether the user generally complies with the rules of the platform (e.g., platform 104) and/or whether the user profile comprises an indication (e.g., a blue check mark, or other indication of being a regular contributor to the platform via comments or other posts exceeding a threshold). If such users are identified, processing may proceed to 1110. On the other hand, if a user having only recently created their account, having a low number of comments or posts, or being known to post spam or expletives on platform 104 or other platforms is identified, the reactions of such users (e.g., user 119) may be discarded from subsequent analysis steps or less heavily weighted in comparison to verified users.

At 1110, the control circuitry may determine, for each identified reaction (e.g., 112, 114, 116, 118, and 120 of FIG. 1), whether the reaction is sufficiently related to the content. For example, the control circuitry may identify one or more text portions, image portions, video portions, audio portions, or any other suitable portions, of content 108, and may use any suitable computer-implemented techniques (e.g. machine learning models, such as, for example, trained model 700 of FIG. 7), and/or analyze metadata of content 108, to obtain a semantic understanding of content 108. The control circuitry may perform a similar analysis for each of the identified reactions to the content, and may compare the obtained semantic (and/or sentiment-based) understanding of the content to each respective obtained semantic understanding of an identified reaction. For example, characteristics of each reaction may be represented by a vector, and compared to a vector representing the content in a vector space, to determine whether a particular reaction is sufficiently similar to the content. In some embodiments, a number of words or other portions of content that overlap with words or other portions of a reaction may be used, at least in part, to determine similarity. In some embodiments, a level of interaction with a comment by other users may be used, at least in part, to determine if a comment is relevant to an original post. For example, if a particular comment has a large number of likes or responses thereto, such comment may be more likely to be relevant to the original content. In some embodiments, only reactions from verified users may be considered at 1108. In some embodiments, reactions determined not to be sufficiently similar to the content may be discarded from the subsequent analysis steps.

At 1112, the control circuitry may identify a number of reactions having been determined at 1108 to be from a verified user and having been determined at 1110 to be sufficiently related to the content (e.g., content 108 of FIG. 1), and compare such number of reactions to threshold. If the number of reactions exceeds the threshold, processing may proceed to 1114; otherwise processing may return to 1102 to wait for more reactions to the content or to identify other content that may be a better candidate for being regenerated. This may allow computing resources to be conserved for content having a sufficient number of reactions that are both sufficiently related to the original content and received from trustworthy users.

At 1114, the control circuitry may input, to a first machine learning model (e.g., trained machine learning model 700) data indicating one or more of the reactions (e.g., data 702 of FIG. 7) having been determined to be received from a verified user and relevant to the original content. At 1116, the control circuitry may receive as output from the first machine learning model sentiment data indicating a sentiment of the plurality of reaction (e.g., at output 704). For example, each reaction may be classified as positive, negative, or neutral in relation to the originally posted content. In some embodiments, the first machine learning model may receive an suitable number of reactions as input, and output a comprehensive output indicating whether and where is the negative sentiment (or whether and where is another type of sentiment), instead of doing so for each of the reactions.

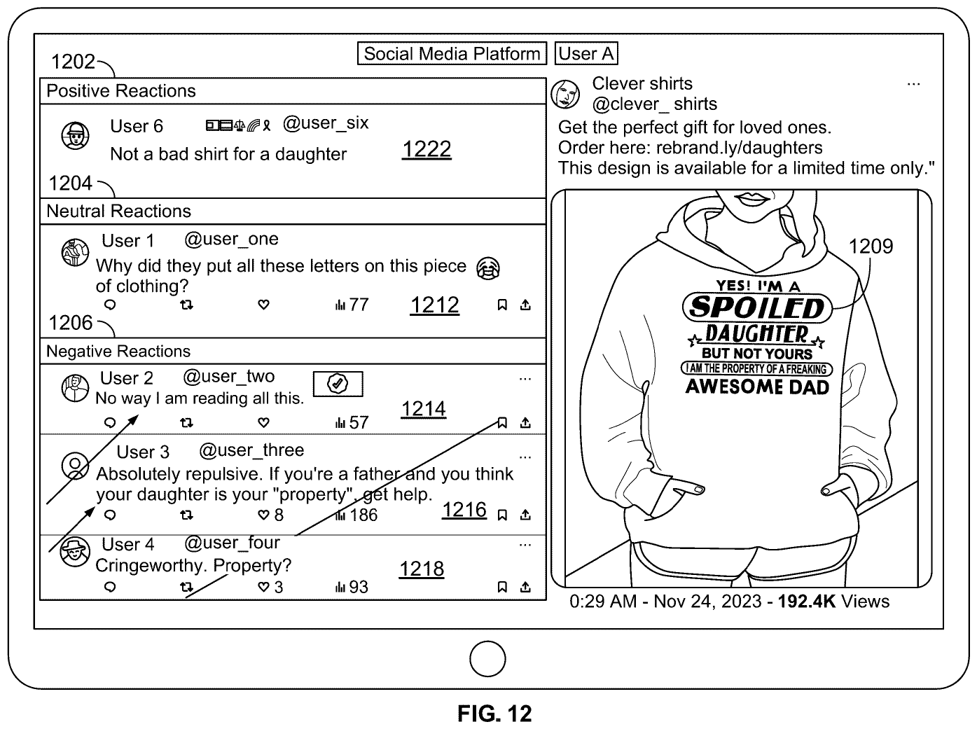

In some embodiments, as shown in FIG. 12, the control circuitry may cause the display of the reactions to the content (e.g., the originally posted content 1209 of FIG. 12) to be ordered and grouped based on their sentiment classification. For example, comment 1222, classified as having a positive reaction to content 1209, may be provided in a positive reactions group 1202; comment 1212, classified as having a neutral reaction to content 1209, may be provided in a neutral reactions group 1204; and comments 1214, 1216, and 1218, classified as having a negative reaction to content 1209, may be provided in a negative reactions group 1206. In some embodiments, the control circuitry may prevent the display of reactions that are unrelated to content 1209 or determined to have been received from unverified users (e.g., comment 120 of FIG. 1). In some embodiments, comments segmented as positive, neutral and negative may be organized in separate sets during the re-rendering step of the social media feed so that the user can quickly focus on the right set that they are interested in.

At 1118, the control circuitry may determine whether a number of reactions with a negative sentiment (e.g., reactions 114, 116, and 118 of FIG. 1) exceeds a threshold, or exceeds a number of other reactions (e.g., having positive and/or neutral sentiments), e.g., with or without reference to a threshold. For example, if content has an overwhelming number of comments with negative sentiment towards the content, the content may be a good candidate for modification. In some embodiments, the control circuitry may glean potential updates to the content even from neutral or positive comments, e.g., a comment such as “This is pretty cool, but it would be nice if that cushion was available in green,” may be have an overall positive sentiment, but nonetheless provide useful data which can be used to generate an updated version of the content.

In some embodiments, a total number of comments having a particular statement may not be determinative. For example, if content has 50 positive comments with a few likes or other interactions each, but one negative comment with 5000 likes or other interactions, the control circuitry may determine that the one negative comment with many more interactions (e.g., above a threshold, and/or as compared to interactions with comments of other sentiments) has enough weight to trigger a regeneration, despite there being significantly more comments of positive sentiment. In some embodiments, at 1118, the control circuitry may check whether opinions expressed in the negative comments are opposed by opinions in the positive or neutral comments. If no opposing sentiments are found, e.g., no positive sentiment, this may trigger steps to perform regeneration of the content. The control circuitry may take into account the total number of comments having a particular sentiment, the reputation of a user posting the comments, a number of interactions with the content, and/or any other suitable data, in determining how to weight the differing sentiments and whether to trigger a regeneration of the originally posted content. In some embodiments, one or more of the thresholds discussed in relation to FIG. 11 may be a default value or a dynamically determined value, and/or may be based on analysis of historical user interactions with content that was regenerated using the techniques described herein.

At 1120, the control circuitry may identify, as at least one portion of the content that is to be modified, a portion(s) of the content corresponding to a portion(s) of reaction(s) having the negative sentiment. For example, the control circuitry may identify portions (e.g., text, image, video and/or audio) appearing in a particular reaction that also appear in the originally posted content, e.g., the word “property” in the example of FIG. 1, and the word “god” and reference to an image of feet 222 in FIG. 2. At 1122, the control circuitry may determine which of such portions appears most frequently amongst the reactions or appears more than a threshold number of times. For example, the control circuitry may determine that the word “property” appears in a majority of the comments having the negative sentiment in the example of FIG. 1, or a majority of the reactions overall.

At 1124, the control circuitry may obtain a positive sentiment or neutral sentiment counterpart to the identified portion. For example, the control circuitry may use an LLM or other machine learning model (e.g., machine learning model 710 of FIG. 7B) to identify a positive or neutral replacement portion of “proud daughter of” for “property of” in the context of “spoiled daughter . . . I am the property of a freaking awesome dad.” As another example, a replacement for the seat cushion shown in content 209 may be identified based on the reactions from users, e.g., a cushion of a different color, or a different product being mentioned in the reactions. In some embodiments, the user preferences of a user may be taken into account, e.g., of user 105, in determining a suitable replacement portion and/or when regenerating the content. The control circuitry may generate a counterpart for any suitable portion of text (e.g., a word, phrase, sentence, or paragraph of text or transcribed text corresponding to audio or text corresponding to a natural language description of an image).

At 1126, the control circuitry may input to a second machine learning model (e.g., trained machine learning model 720), data indicative of the content (e.g., any suitable portion of content 108, such as, for example, the portion the text and/or media portion associated with the word “property” on the sweatshirt of content 108 of FIG. 1) and data indicative of the portion of the content for modification (e.g., the replacement portion identified at 1124). In some embodiments, the input to the second machine learning model may include an indication to omit certain portions of the original content (e.g., the word “freaking” in FIG. 1 due to it being arguably offensive, or the depiction of feet 222 due to a reaction indicating it was “gross”) from the regenerated version. In some embodiment, a text-to-image machine learning model may be employed to generate the corrected version of the content, e.g., based on a natural language description of what the updated content should look like.

At 1128, the control circuitry may receive, as output from the second machine learning model, a modified version of the content (e.g., regenerated version 136 of content 108 of FIG. 1). At 1130, the control circuitry may cause the content (e.g., content 108 of FIG. 1) to be modified based on (e.g., replaced with) such regenerated version of the content, or to be supplemented with such regenerated version of the content (e.g., the regenerated version of the content may be added as a comment on the original post 107 of FIG. 1 or as a response to one or more of the comments having the negative sentiments). In some embodiments, the response may include a hyperlink to the new version of the content. In some embodiments, the system may link the comments that have been addressed by the corrected version of the content to the original version of the content, and provide the new content as a separate post.

In some embodiments, the techniques described herein may be used to dynamically modify any suitable form of content. For example, if feedback on a movie indicates complaints about an ending of the movie or a portion of a finale of an episode of a season, the control circuitry may generate a new ending to substitute for the original portion of the content. In some embodiments, the substitute content may be generated based at least in part on user preferences.

In some embodiments, specific users may be provided with different regenerated versions of content, e.g., similar users or all users having the negative sentiment may be shown the same regenerated content, and other similar users or all users having the positive sentiment may be shown the original content or another version of the content. In some embodiments, users on different platforms may react to the same content differently, and regenerated versions of the content may be selectively applied to specific platforms based on the feedback.

In some embodiments, the regenerating of content may be part of an advertisement bidding process. For example, if an advertiser buys one million advertisements to users, and 200,000 get a negative reaction, the control circuitry may show the corrected version to the remaining 800,000. If the advertiser decides to correct the advertisement, the remaining advertisements may be reduced, e.g., to 700,000 more users that can be shown the corrected advertisement.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
identifying content being displayed on a social media platform;
identifying a plurality of reactions to the content from a plurality of users of the social media platform;
inputting, to a first machine learning model, data indicating the plurality of reactions;
receiving, as output from the first machine learning model, sentiment data for the plurality of reactions;
determining, based on the sentiment data output from the first machine learning model, at least one reaction of the plurality of reactions having a negative sentiment;
identifying, as at least one portion of the content that is to be modified, a portion of the content corresponding to a portion of the at least one reaction having the negative sentiment;
inputting, to a second machine learning model, data indicating at least a portion of the content and data indicating the identified portion of the content;
receiving, as output from the second machine learning model, a regenerated version of the content; and
causing the content on the social media platform to be modified based on, or supplemented with, the regenerated version of the content.

2. The method of claim 1, wherein the sentiment data classifies each reaction of the plurality of reactions as having a positive sentiment, a neutral sentiment, or a negative sentiment.

3. The method of claim 1, further comprising:
identifying a replacement portion to be used in the regenerated version of the content instead of the identified portion of the content, the replacement portion having a positive or a neutral sentiment;
wherein the replacement portion corresponds to the data indicating the identified portion of the content that is input to the second machine learning model.

4. The method of claim 1, wherein:
the plurality of reactions comprise a plurality of comments posted to the social media platform in association with the content;
receiving, as the output from the first machine learning model, the sentiment data for the plurality of reactions comprises receiving data indicating a number of the plurality of comments having a negative sentiment; and
the method further comprising identifying a replacement portion to be used in the regenerated version of the content instead of the portion of the content is performed in response to determining that a number of the first plurality of comments that reference the identified portion of the content exceeds a threshold.

5. The method of claim 1, wherein:
the plurality of reactions comprise a plurality of comments posted to the social media platform in association with the content; and
receiving, as the output from the first machine learning model, the sentiment data for the plurality of reactions comprises receiving data indicating a number of the plurality of comments having a negative sentiment; and
inputting, to the second machine learning model, the data indicating at least a portion of the content and the data indicating the identified portion of the content is performed in response to determining that the number of the plurality of comments having the negative sentiment exceeds a threshold.

6. The method of claim 1, wherein:
the data indicating the identified portion of the content that is input to the second machine learning model comprises an indication to omit the identified portion of the content from the regenerated version of the content.

7. The method of claim 1, wherein:
the plurality of reactions comprise a plurality of comments posted to the social media platform in association with the content; and
the method further comprises:
determining that a number of interactions with at least one comment of the plurality of comments exceeds a threshold; and
using the second machine learning model to regenerate the content as modified content based at least in part on determining that the number of interactions with the at least one comment exceeds the threshold.

8. The method of claim 1, wherein the plurality of reactions comprise a plurality of comments related to the content, and identifying the plurality of reactions to the content from the plurality of users of the social media platform comprises:
for each respective user of the plurality of users, analyzing profile data of the user to determine whether a user profile of the user is a valid user profile;
for each respective comment of the plurality of comments, analyzing text of the comment to determine whether the comment is relevant to the content; and
identifying the plurality of reactions to the content from the plurality of users of the social media platform based on determining that:
each of the plurality of users is associated with a valid user profile; and
each of the plurality of comments is relevant to the content.

9. The method of claim 1, further comprising:
identifying a number of users that have reacted to the content or viewed the content;
determining that the number of users is above a threshold number; and
in response to determining that the number of users is above the threshold number, inputting, to the first machine learning model, the data indicating the plurality of reactions.

10. The method of claim 1, further comprising:
identifying a first number of users that have viewed the content without commenting on, liking, disliking, or sharing the content;
identifying a second number of users that have interacted with the content by commenting on, liking, disliking, or sharing the content;
determining a ratio of the first number to the second number; and
in response to determining that the ratio exceeds a threshold, inputting, to the first machine learning model, the data indicating the plurality of reactions.

11. The method of claim 1, further comprising:
transmitting a recommendation, to a content provider associated with the content, to replace the content with the regenerated version of the content,
wherein causing the content on the social media platform to be modified based on, or supplemented with, the regenerated version of the content is performed in response to receiving an indication from the content provider approving of the recommendation.

12. The method of claim 1, wherein inputting, to the second machine learning model, the data indicating the at least a portion of the content and the data indicating the identified portion of the content is further performed based on determining that at least one of the plurality of reactions indicates that the content comprises data that is false or offensive.

13. The method of claim 1, further comprising:
determining a first user is currently viewing the content on the social media platform via a first computing device, and that a second user is currently viewing the content on the social media platform via a second computing device;
identifying first user preferences associated with the first user, and identifying second user preferences associated with the second user; and
wherein the second machine learning model is configured to regenerate the content by:
regenerating the content as first modified content, based at least in part on the first user preferences;
regenerating the content as first modified content based at least in part on the second user preferences; and
wherein causing the content on the social media platform to be modified based on, or supplemented with, the regenerated version of the content comprises:
causing the content to be modified based on, or supplemented with, the first modified content at the first computing device of the first user; and
causing the content to be modified based on, or supplemented with the second modified content at the second computing device of the second user.

14. The method of claim 1, wherein the social media platform is a first social media platform, the plurality of reactions is a first plurality of reactions, and the plurality of users is a first plurality of users, and the method further comprises:
determining the content is being displayed on a second social media platform;
identifying a second plurality of reactions to the content from a second plurality of users of the second social media platform;
inputting, to the first machine learning model, data indicating the second plurality of reactions;
receiving, as output from the first machine learning model, sentiment data for the second plurality of reactions; and
in response to determining, based on the sentiment data for each of the second plurality of reactions output from the first machine learning model, that none of the second plurality of reactions have a negative sentiment or that less than a threshold number of the second plurality of reactions have a negative sentiment, maintaining the content on the second social media platform.

15. The method of claim 1, further comprising:
providing for display the plurality of reactions; and
based on the sentiment data for the plurality of reactions, modifying the display of the plurality of reactions to:
group a first subset of the plurality of reactions having a positive sentiment together;
group a second subset of the plurality of reactions having a negative sentiment together; and
group a third subset of the plurality of reactions having a neutral sentiment together.

16. The method of claim 1, wherein:
the content comprises text data;
the second machine learning model is a large language model;
the data indicating at least a portion of the content, input to the second machine learning model, comprises at least a portion of the text data; and
the data indicating the identified portion of the content, input to the second machine learning model, comprises an indication of an identified portion of the text that is determined, based on the sentiment data, to be modified or omitted in the regenerated version of the content; and
a command requesting the text data to be regenerated based on the identified portion of the text is input to the machine learning model.

17. A system, comprising:
control circuitry configured to:
identify content being displayed on a social media platform;
identify a plurality of reactions to the content from a plurality of users of the social media platform;
input, to a first machine learning model, data indicating the plurality of reactions;
receive, as output from the first machine learning model, sentiment data for the plurality of reactions;
determine, based on the sentiment data output from the first machine learning model, at least one reaction of the plurality of reactions having a negative sentiment;
identify, as at least one portion of the content that is to be modified, a portion of the content corresponding to a portion of the at least one reaction having the negative sentiment;
input, to a second machine learning model, data indicating at least a portion of the content and data indicating the identified portion of the content;
receive, as output from the second machine learning model, a regenerated version of the content; and
cause the content on the social media platform to be modified based on, or supplemented with, the regenerated version of the content.

18. The system of claim 17, wherein the sentiment data classifies each reaction of the plurality of reactions as having a positive sentiment, a neutral sentiment, or a negative sentiment.

19. The system of claim 17, wherein the control circuitry is further configured to:
identify a replacement portion to be used in the regenerated version of the content instead of the identified portion of the content, the replacement portion having a positive or a neutral sentiment;
wherein the replacement portion corresponds to the data indicating the identified portion of the content that is input to the second machine learning model.

20. The system of claim 17, wherein:
the plurality of reactions comprise a plurality of comments posted to the social media platform in association with the content; and
wherein the control circuitry is further configured to:
receive, as the output from the first machine learning model, the sentiment data for the plurality of reactions comprises receiving data indicating a number of the plurality of comments having a negative sentiment; and
identify a replacement portion to be used in the regenerated version of the content instead of the portion of the content in response to determining that a number of the first plurality of comments that reference the identified portion of the content exceeds a threshold.

21-80. (canceled)
